(19) United States
(12) Patent Application Publication
(10) Pub. No.: US 2026/0146131 A1
(43) Pub. Date: May 28, 2026

(54) HEAT-RESISTANT POLYSULFATES AND METHODS OF THEIR USE

(71) Applicants: THE SCRIPPS RESEARCH INSTITUTE, La Jolla, CA (US); THE REGENTS OF THE UNIVERSITY OF CALIFORNIA, Oakland, CA (US)

(72) Inventors: Yi LIU, Oakland, CA (US); K. Barry SHARPLESS, La Jolla, CA (US); Peng WU, La Jolla, CA (US); Zongliang XIE, Oakland, CA (US); Hongbo ZHENG, La Jolla, CA (US)

(73) Assignees: THE SCRIPPS RESEARCH INSTITUTE, La Jolla, CA (US); THE REGENTS OF THE UNIVERSITY OF CALIFORNIA, Oakland, CA (US)

(21) Appl. No.: 19/393,783

(22) Filed: Nov. 19, 2025

Related U.S. Application Data
(60) Provisional application No. 63/723,716, filed on Nov. 22, 2024.

(51) Int. Cl. C08G 75/24; C08K 3/22; C08K 3/28

(52) U.S. Cl. CPC C08G 75/24; C08K 3/22; C08K 3/28; C08K 2003/221; C08K 2003/222; C08K 2003/2227; C08K 2003/2244; C08K 2003/2296; C08K 2003/282

(57) ABSTRACT

Disclosed herein are dielectric polymers of formula I

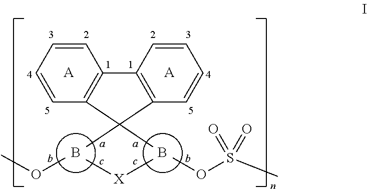

the variables of which are defined herein, as well as methods and compounds useful in the synthesis of the polymers and materials comprising and methods of using the polymers.

### CROSS-REFERENCE TO RELATED APPLICATION

This application claims priority to 63/723,716, filed Nov. 22, 2024, the entirety of which is incorporated herein by reference.

### GOVERNMENT SUPPORT

This invention was made with government support under CHE-1610987 awarded by the National Science Foundation: DE-AC02-05CH11231 awarded by the U.S. Department of Energy: R35GM139643 awarded by the National Institutes of Health. The government has certain rights in the invention.

### INCORPORATION BY REFERENCE

Text for a large table submitted herewith as an ASCII text file named “Table1.txt”, having a size of 7,626,788 bytes and created Nov. 17, 2025, is incorporated herein by reference. This table is referred to herein as “Table 1”.

LENGTHY TABLES
The patent application contains a lengthy table section. A copy of the table is available in electronic form from the USPTO web site (https://seqdata.uspto.gov/docdetail?docId=US20260146131A1). An electronic copy of the table will also be available from the USPTO upon request and payment of the fee set forth in 37 CFR 1.19(b)(3).

### 1. BACKGROUND

Dielectric polymers are essential for electrostatic film capacitors owing to their light weight, mechanical flexibility, and ability to withstand high voltages.^{[1,2]} However, these materials are fraught with limitations, one of which is their poor ability to tolerate extreme thermal environments.^{[3-8]} Biaxially oriented polypropylene (BOPP), the industrial standard, performs admirably up to 85° C. but falls short in electrification applications requiring high temperatures well above 150° C., such as inverters in hybrid electric vehicles, underground oil and gas exploration, and aircraft electrification.^{[3-8]} The quest for viable alternatives has turned towards commercial polymers with high glass transition temperatures (T_{g}) polymers, such as polyimide (PI), polyetherimide (PEI), and fluorene polyester (FPE). Unfortunately, most of these conventional dielectric polymers feature relatively narrow electronic bandgaps (E_{g}).^{[8-14]} Consequently, despite their higher T_{g}, these polymers suffer from degraded performance at elevated temperatures and electric fields due to thermally exacerbated charge transport, leading to significant current leakage across polymer films.

A need exists for polymers that provide balanced thermal and electrical properties and that can withstand both temperature and electric field extremes.

### 2. SUMMARY

This invention is directed to dielectric polymers of formula I:

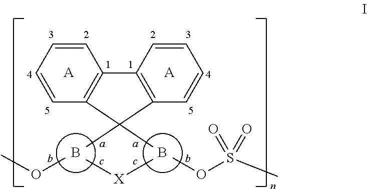

wherein:
each ring A is optionally substituted at one or more of positions 2-5 with R¹ such that the substitution at each of positions 2-5 is the same in each ring A;
each ring B is indenyl, naphthyl, tetrahydronaphthyl, anthryl, or optionally substituted phenyl, which optional substitution is at one or more positions with R² such that the substitution at each of the positions is the same in each ring B;
when B is optionally substituted phenyl, bonds a and b are para and bonds a and c are ortho; when B is indenyl, bonds a and b are 4 carbons apart; when B is naphthyl or tetrahydronaphthyl, bonds a and b are 5 carbons apart; and when B is anthryl, bonds a and b are 7 carbons apart;
each R¹ is independently halo, methyl, CF₃, cyano, phenyl, or SO₂CH₃;
each R² is independently halo, methyl, CF₃, cyano, phenyl, or SO₂CH₃;
X is absent when A is not optionally substituted phenyl; when A is optionally substituted phenyl, X is absent or is a bond, O, S, S(O), CH₂, or C(CH₃) 2; and
n is the average number of repeating units in the polymer and is greater than 100.

In particular embodiments of the invention; when each ring A is unsubstituted phenyl and X is absent or O, B is not unsubstituted phenyl; when each ring A is monosubstituted with R¹ at position 4, R¹ is Br, and X is absent, B is not unsubstituted phenyl; and when each ring A is unsubstituted phenyl, B is not naphthyl.

This invention also encompasses synthetic intermediates and monomers useful in the preparation of the dielectric polymers.

This invention also encompasses materials comprising polymers of the invention, which may be used to store energy in a variety of applications, including hybrid electric vehicles, underground gas exploration, underground gas exploration, airborne device electrification, aircraft electrification, and spacecraft electrification.

### 3. DESCRIPTION OF THE DRAWINGS

Certain aspects of the invention may be understood with reference to the accompanying figures.

FIGS. 1a-b represent the process used to identify polymers of the invention. FIG. 1a shows polysulfate synthesis by SuFEx catalysis and the discovery workflow integrating both machine learning prediction and experimental validation. Abbreviations used: BEMP. 2-tert-Butylimino-2-diethylamino-1,3-dimethyl perhydro-1,3,2-diazaphosphorine: cat., catalytic amount: NMP, N-methyl-2-pyrrolidone; TBS, tert-Butyldimethylsilyl: SMILES, simplified molecular input line entry system: FNN, feedforward neural network: k, dielectric constant: SA, synthetic accessibility. SMILES strings were used to customize the structures of the repeat unit and a pair of asterisks (‘*’) were employed to indicate the two endpoints of the repeat unit. FIG. 1b shows the components used for library design based on different variations of the 9,9-diarylfluorene repeat unit.

FIGS. 2a-f provide dielectric properties of polysulfates. FIG. 2a shows temperature-dependent dielectric spectra of dielectric constant. FIG. 2b shows the dielectric loss tangent of polysulfate P6 and commercial dielectric polymers obtained at 10⁴ Hz. FIG. 2c provides the temperature coefficient (CT) of the dielectric constant of polysulfate P6 and commercial dielectric polymers at various temperature ranges obtained at 10+Hz. FIG. 2d shows hopping conduction fittings of leakage current density versus electric field of polysulfates P4-P6 measured at 200° C. Solid curves represent fittings to hyperbolic sine. FIG. 2e shows Weibull breakdown plots of polysulfates P4, P5 and P6 measured at 200° C. FIG. 2f shows temperature-dependent Weibull breakdown strength of polysulfates P1-P6.

### 4. DETAILED DESCRIPTION

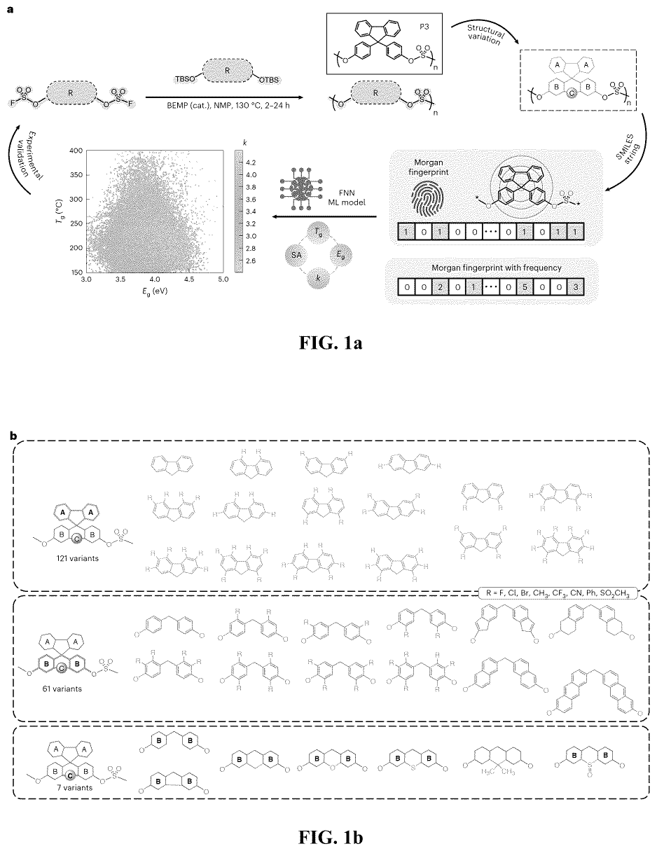

This invention is based, in part, on the design of a series of polysulfate polymers prepared from the building blocks shown in FIG. 1b, which can readily be prepared using SuFEx click chemistry. This invention is further based on machine learning-based predictions of polymer properties, synthesis of promising polymers (e.g., as films), and the characterization of those polymers.

Polymerization reactions, particularly those featuring “click” chemistry attributes, are ideally suited for generating diverse polymer series with robust main-chain linkages and modular structural variations^{[32-35]}. These have been exemplified in the scalable synthesis of a wide variety of polysulfates via the near-perfect sulfur fluoride exchange (SuFEx) catalysis.^{[36-39]} Also see PCT international publication nos. WO2024/091675 and WO2024/091684.

Here, an innovative workflow (FIG. 1a) was used to expedite the discovery of heat-resistant dielectric polymers, which leverages machine learning (ML) as a means of predicting properties of polymers and SuFEx click chemistry as an easy and rapid means of preparing those polymers. We specifically explore the application of ML in identifying polysulfates with well-balanced thermal and electrical parameters, that is, large T_{g} and E_{g}, which are key proxy parameters appropriate as first-order performance indicators. Experimental validation revealed that the screened polysulfates, readily accessible through the modular SuFEx reaction, achieve impressive thermal and electrical properties.

Polymers of this invention are made from the polymerization of symmetrical units comprised of the substructures shown in FIG. 1b, are of general formula I:

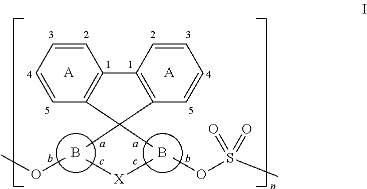

wherein the numbers and lowercase letters refer to positions on rings A and bonds attached to rings B, respectively and:
each ring A is optionally substituted at one or more of positions 2-5 with R¹ such that the substitution at each of positions 2-5 is the same in each ring A;
each ring B is indenyl, naphthyl, tetrahydronaphthyl, anthryl, or optionally substituted phenyl, which optional substitution is at one or more positions with R² such that the substitution at each of the positions is the same in each ring B;
when B is optionally substituted phenyl, bonds a and b are para and bonds a and c are ortho; when B is indenyl, bonds a and b are 4 carbons apart; when B is naphthyl or tetrahydronaphthyl, bonds a and b are 5 carbons apart; and when B is anthryl, bonds a and b are 7 carbons apart;
each R¹ is independently halo, methyl, CF₃, cyano, phenyl, or SO₂CH₃;
each R² is independently halo, methyl, CF₃, cyano, phenyl, or SO₂CH₃;
X is absent when A is not optionally substituted phenyl; when A is optionally substituted phenyl, X is absent or is a bond, O, S, S(O), CH₂, or C(CH₃) 2; and
n is the average number of repeating units in the polymer and is greater than 100.

In particular embodiments of the invention; when each ring A is unsubstituted phenyl and X is absent or O, B is not unsubstituted phenyl; when each ring A is monosubstituted with R¹ at position 4, R¹ is Br, and X is absent, B is not unsubstituted phenyl; and when each ring A is unsubstituted phenyl, B is not naphthyl.

One embodiment of the invention is directed to polymers of formula II:

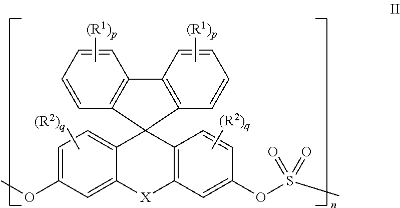

wherein p is 0-3 and q is 0-3.

Particular polymers are of formulae II(a), II(b), and III(c):

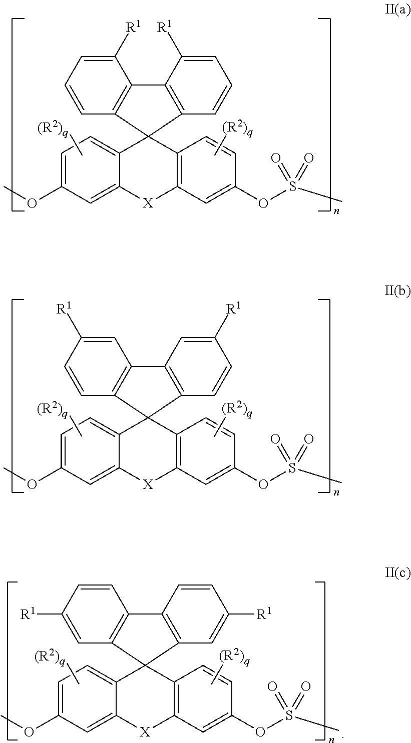

Another embodiment of the invention is directed to polymers of formula III:

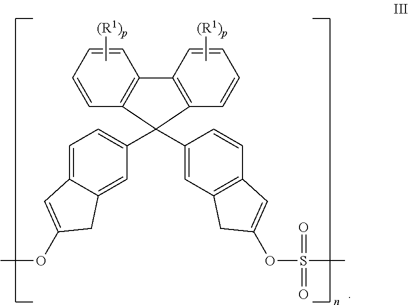

Another embodiment of the invention is directed to polymers of formula IV:

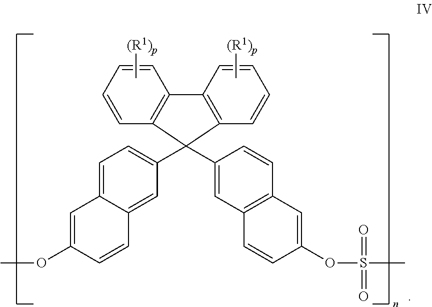

Another embodiment of the invention is directed to polymers of formula V:

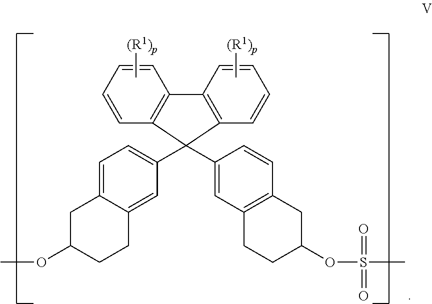

Another embodiment of the invention is directed to polymers of formula VI:

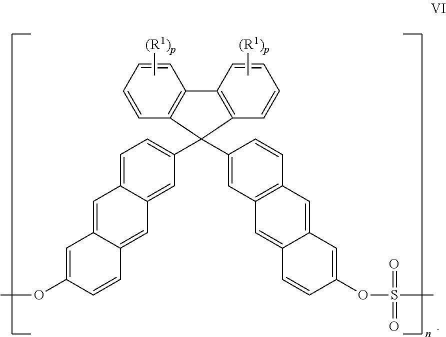

In each of these embodiments, the value n is the average number of repeating units within the brackets of the formula and has a value sufficient to provide a number average molecular weight (Mₙ) of at least about 7,000 g mol⁻¹ (e.g., at least 10,000, 15,000, 20,000, 30,000, 50,000, 80,000, 100,000, 150,000, or 200,000 g mol⁻¹) as determined by size exclusion chromatography (SEC) using styrene-divinyl benzene columns, DMF/0.2% LiBr elution solvent, and polystyrene molecular weight standards.

Specific compounds of the invention are listed, in SMILES format, in Table 1.

Preferred polymers are heat-resistant dielectric polymers with well-balanced thermal and electrical parameters. Particular polymers have a glass transition temperature (T_{g}) that is greater than 200° C. (e.g., greater than 210, 220, 230, 240, 250, 260, or 270° C.). Particular polymers have a band gap (E_{g}) greater than 3.6 eV (e.g., greater than 3.65, 3.7, 3.75, or 3.8 eV). Particular polymers have a dielectric constant (k) greater than 2.3 (e.g., greater than 2.4, 2.5, 2.75, 3.0, 3.25).

Some particular polymers are shown below:

TABLE 2

| | |
|---|---|
| | 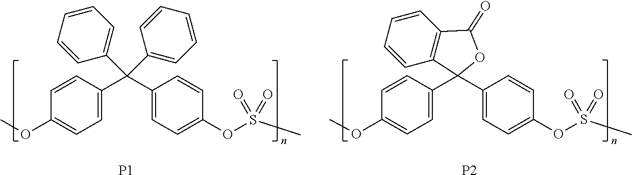 |
| | 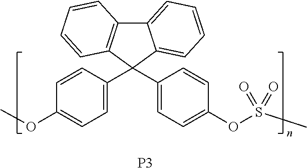 |
| T_{g} > 255° C., E_{g} > 3.75 eV, k > 3.25, SA < 3.75 | 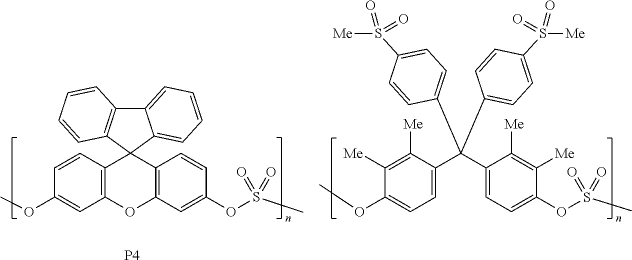 |
| | 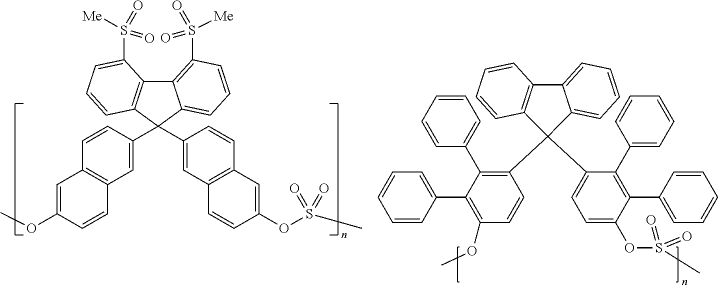 |
| T_{g} > 235° C., E_{g} > 3.80 eV, k > 2.5, SA < 3.26 | 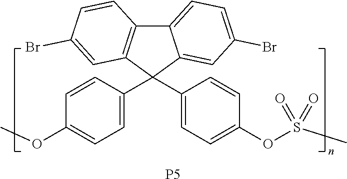 |
| T_{g} > 270° C., E_{g} > 3.75 eV, k > 3.0, SA < 3.40 | 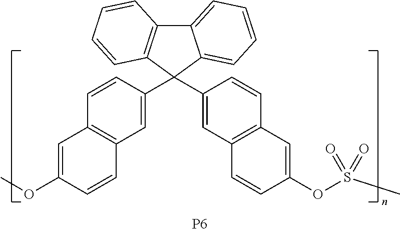 |

As described in detail below, polymers P4, P5, and P6 were successfully synthesized using this approach and their structure confirmed by NMR, GPC and FTIR analyses. Differential scanning calorimetry (DSC) and UV-vis spectroscopy were employed to investigate their T_{g} and E_{g} values. Notably, all three demonstrated an E_{g} above 3.7 eV and a T_{g} exceeding 240° C., with P6 exhibiting an outstanding T_{g} over 300° C.

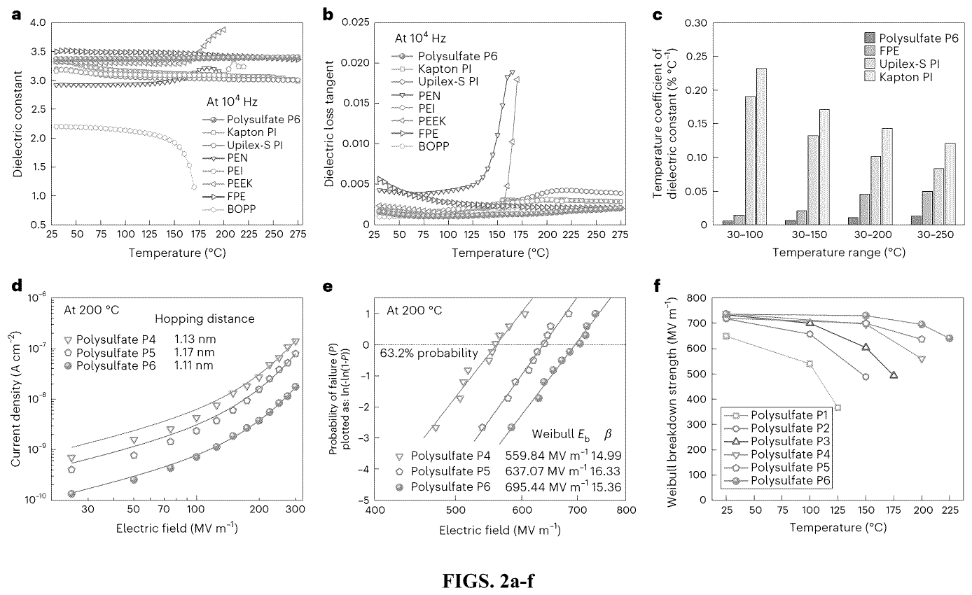

These results position P6 as most promising in thermal resilience compared to recently reported dielectric polymers across the PEI^{[29]}, PI^{[12-14, 29]}, and polyolefin and polynorborene families^{[8, 52-55]} See FIGS. 2a-c. In comparison, widely used commercial aromatic polymers, such as PEI (Ultem), PI (Upilex PI and Kapton PI), FPE, and polyamideimide (PAI), exhibit a notable decrease of E_{g} (below 3.4 eV) when the T_{g} exceeds 200° C. Aside from high T_{g} and E_{g} values, all three polysulfates exhibit favorable k values (e.g., 3.2-3.5 at 10⁴ Hz) and low loss tangents (tan d, e.g., <0.25% at 10⁴ Hz), as revealed by frequency-dependent dielectric spectra. Moreover, these polysulfates have relatively low computed mass densities (˜1.17-1.43 g cm⁻³) and high thermal stability with thermal decomposition temperatures above 340° C. and excellent solubility in common polar solvents that enables the facile solution casting of flexible, free-standing thin films. The synergistic combination of ease of processing, lightweight, wide E_{g}, high T_{g}, and relatively high k is essential for applications in heat-resistant film capacitors.^{[4, 7, 10, 56-58]}

The polymers of this invention can be used to prepare films. One embodiment of the invention is a dielectric film comprising a first layer and a second layer, wherein the first layer comprises a dielectric polymer of any of the previous claims and the second layer comprises an inorganic dielectric material.

Examples of inorganic dielectric materials include metal oxides and metal nitrides. Particular inorganic dielectric material include Al₂O₃, AlN, BN, HfO₂, MgO, SiO₂, SnN, SnO₂, TaN, TiO₂, Y₂O₃, ZnO, and ZrO₂.

In some embodiments, the first layer has a thickness of from 1 to 15 μm. In some embodiments, the second layer has a thickness of from 4 to 6 nm.

This invention also encompasses a material for storing electrostatic energy, which material comprises a first conductive layer, a second conductive layer, and a dielectric polymer of the invention disposed between the first and second conductive layers. In some embodiments, at least one of the first and second conductive layers comprises aluminum (Al), copper (Cu), gold (Au), niobium (Nb), platinum (Pt), or tantalum (Ta).

### 4.1. Definitions

Unless otherwise indicated, the term “about” means±10% of the indicated range.

When used herein, the term “alkenyl” is accorded its conventional meaning. Examples of alkenyl moieties include straight-chain and branched C₂₋₂₀, C₂₋₁₂ and C₂₋₆ alkenyl such as vinyl, allyl, 1-butenyl, 2-butenyl, isobutylenyl, 1-pentenyl, 2-pentenyl, 3-methyl-1-butenyl, 2-methyl-2-butenyl, 2,3-dimethyl-2-butenyl, 1-hexenyl, 2-hexenyl, 3-hexenyl, 1-heptenyl, 2-heptenyl, 3-heptenyl, 1-octenyl, 2-octenyl, 3-octenyl, 1-nonenyl, 2-nonenyl, 3-nonenyl, 1-decenyl, 2-decenyl and 3-decenyl.

The term “alkyl” is accorded its conventional meaning. Examples of alkyl moieties include straight-chain and branched C₁₋₂₀ alkyl, C₁₋₁₂ alkyl, C₁₋₆ alkyl, C₁₋₄ alkyl, and C₁₋₃ alkyl, such as methyl, ethyl, propyl, isopropyl, n-butyl, t-butyl, isobutyl, pentyl, hexyl, isohexyl, heptyl, 4,4-dimethylpentyl, octyl, 2,2,4-trimethylpentyl, nonyl, decyl, undecyl, and dodecyl. Unless otherwise indicated, the term “alkyl” encompasses cycloalkyl.

The term “alkynyl” is accorded its conventional meaning. Examples of alkynyl moieties include straight-chain and branched C₂₋₂₀, C₂₋₁₂ and C₂₋₆ alkynyl, such as ethynyl and 2-propynyl (propargyl).

The term “aryl” refers to a single all-carbon-backbone aromatic ring or a multiple condensed all-carbon-backbone ring system wherein at least one of the rings is aromatic. Examples include C₆₋₂₀, C₆₋₁₄, C₆₋₁₂, and C₂₋₁₀ rings and multiple condensed carbon ring systems (e.g., ring systems comprising 2, 3 or 4 rings) having 9 to 20 carbon atoms in which at least one ring is aromatic and wherein the other rings may be aromatic or not aromatic. The rings of multiple condensed ring systems may be connected to each other via fused, spiro, or bridged bonds when valency allows. Examples of aryl moieties include anthracenyl, azulenyl, fluorenyl, indanyl, indenyl, naphthyl, phenyl, phenanthrenyl, and 1, 2, 3, 4-tetrahydronaphthyl.

The term “halo” encompass fluoro, chloro, bromo, and iodo.

The term “include” has the same meaning as “include, but are not limited to,” and the term “includes” has the same meaning as “includes, but is not limited to.” Similarly, the term “such as” has the same meaning as the term “such as, but not limited to.”

Unless otherwise indicated, an adjective before a string of nouns should be construed to apply to each. For example, the phrase “optionally substituted pyridyl, pyrazyl, or furanyl” means the same as “optionally substituted pyridyl, optionally substituted pyrazyl, or optionally substituted furanyl”.

A wavy line “ [symbol] ” that intersects a bond in a chemical structure indicates the point of attachment of the bond that the wavy bond intersects in the chemical structure to the remainder of a molecule. Similarly, an asterisk “*” positioned at the end of a bond indicates its point of attachment to another chemical moiety.

### 4.2. Polymer Screening, Synthesis, and Characterization

### 4.2.1. High Throughput Screening

Polysulfates featuring the 9,9-diarylfluorene repeat unit, such as P3, have previously illustrated an elegant balance between T_{g} and E_{g}, showcasing their potential as heat-resistant dielectric polymers for electrostatic energy storage applications. Inspired by the structural features of P3, our library design retains the fluorene core within the repeat units while introducing systematic variations to the substituents at three distinct sites. As depicted in FIG. 1b, a range of substituents and ring-fused structures are introduced on both the fluorene ring systems and the 9,9-aryl groups. Moreover, we experimented with different bridging units between the two 9,9-aryl groups to assess the influence of more rigid fused ring systems on the polymers' physical properties of interest. To optimize computational effects and alleviate synthetic complications, we focus on homopolymers formed from symmetrical monomers, culminating in a curated library of 49,731 polysulfates with notable structural diversity.

We then implemented a customized feed-forward neural network (FNN) model to screen the library of polysulfates with a particular focus on T_{g} and E_{g}, the two pivotal parameters for heat-resistant polymers. Our previous benchmark study established that among various machine learning methods, FNNs demonstrate superior generalization capabilities with ample training data, enabling more accurate predictions for polymers outside of the training set.^{[40-43]} The polymer structures were represented by polymer-simplified molecular input line entry system (p-SMILES) strings generated using RDKit⁴⁴, where SMILES strings were used to customize the structures of the repeat unit and a pair of asterisks (***) were employed to indicate the two endpoints of the repeat unit. p-SMILES, being widely adopted in machine learning studies for representing polymeric structures^{[45,46]}, stands out among various molecule representations due to its high computational efficiency, case of adoption and readability and comprehensibility by both humans and machines. For predicting the T_{g} values, the Morgan fingerprint with frequency, known for its efficiency and robustness in generating interpretable molecular representations of polymers^{[40,47]}, was employed as the input for the FNN model. In contrast, for the prediction of Ex values, a 1,024-bit Morgan fingerprint was utilized.

To train the FNNs, a dataset was compiled from the Polymer Genome^{[48]} that consisted of 6,906 polymers with reported T_{g} values and 3,381 polymers with reported E_{g} values. T-distributed stochastic neighbor embedding (t-SNE), a nonlinear dimensionality reduction and data visualization technique for visualizing these high-dimensional data in a two-dimensional space, was used to reveal distinctions between the two sets of structures. To enhance the predictive accuracy of our FNNs for new polysulfates, a resampling method was employed by enriching the training dataset with 14 polysulfates^{[37,49]} with known T_{g} values and duplicating these to adjust their representation from the original 0.20% (14/6,906) to 5% of the total dataset. A similar strategy was employed for Eₛ predictions by increasing the representation of 30 polysulfates^{[37,49]} with experimentally measured Eₛ values from 0.89% (30/3,381) to 9% in the respective training set. The FNNs, trained on 90% of these samples and tested on the remaining 10%, achieved R₂ of 0.99 and 0.92 for T_{g} prediction and 0.99 and 0.90 for E_{g} prediction in the training and validation phases, respectively. For dielectric constant (k) predictions, a similar FNN was utilized without the resampling method.

The model also incorporated a synthetic accessibility (SA) score matrix^{[50]} to assess the synthesis feasibility of the polysulfate library. By concurrently considering all three properties (T_{g}, E_{g}, and k) and applying specific SA score cut-offs, selection criteria were established for identifying polysulfate candidates for synthesis and testing.

Results of those outcomes are provided in Table 1, which contains in comma separated values (csv) format a p-SMILES description for each polymer and predicted values for T_{g}, E_{g}, k, and SA.

### 4.2.2. Polymer Synthesis

Polymers were prepared from symmetric monomers based on the combination of the three structural elements shown in FIG. 1b. These monomers are represented by the generic formulae below:

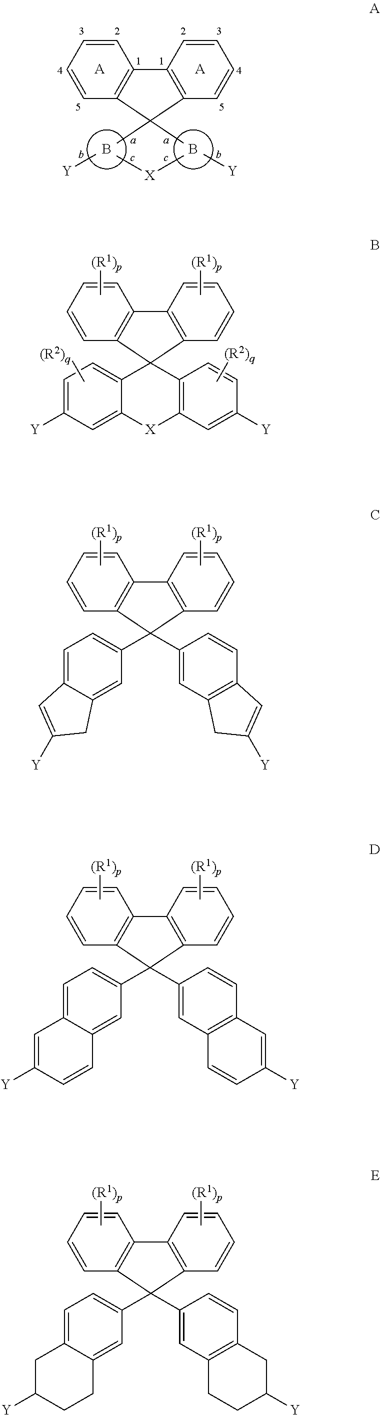

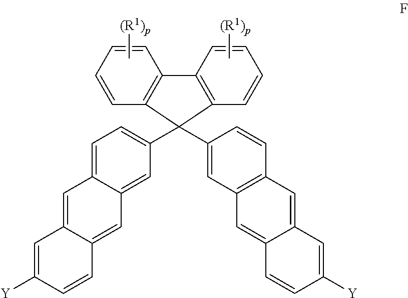

wherein X, R¹, R², p, and q are defined above (e.g., for formula II) and Y is OTBS or OSO₂F. These monomers are readily prepared from the corresponding bis-hydroxy compounds, for example:

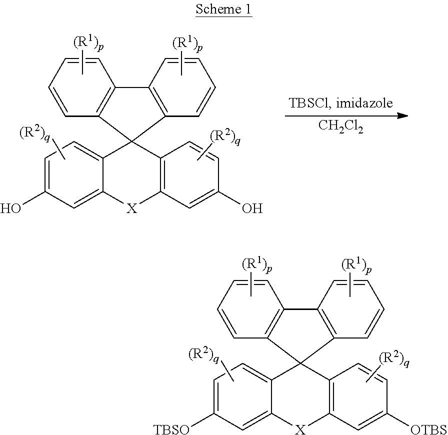

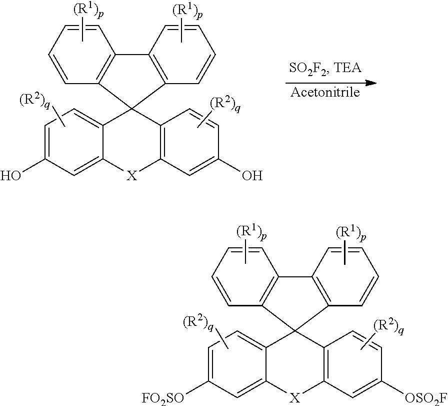

The two precursors are then contacted with a suitable catalyst to yield a polymer of the invention:

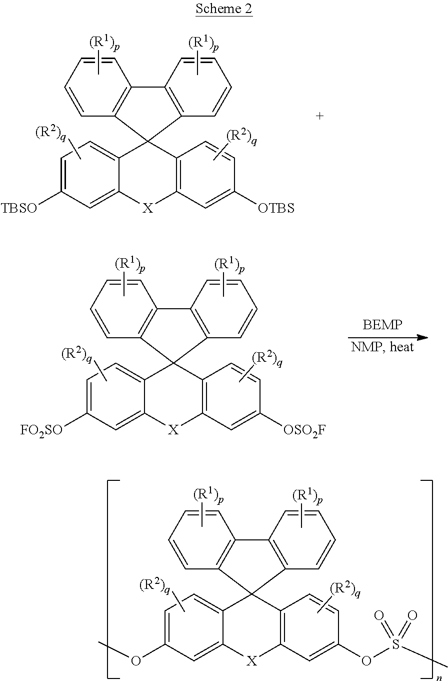

Monomers, or precursors, that can be used to prepare the polymers are commerically available and/or readily prepared by known methods. See, e.g., WO 2013/032190; US 2025/0163215; WO 2025/187313; CN 103304558B; Zhou, Y., et al., “A convenient one-pot preparation of spiro[fluorene-9,9′-xanthene]-3′,6′-diol derivatives” ARKIVOC 2015 (v) 99-109; Rashid, S., et al., “Fluorinated [2]rotaxanes with spirofluorene motifs: a non-symmetric distribution of the ring component along the axle component” New J. Chem., 2023; 47:900; and Li, Y., et al., “Rigid and crosslinkable polyimide curing epoxy resin with enhanced comprehensive performances” Polymer 2024; 297:126836.

### 4.2.3. Dielectric Properties

To assess the dielectric stability of polysulfates, we first compared the frequency-dependent dielectric spectra of P4, P5, and P6 at different temperatures. Notably, the dielectric spectrum of all three polysulfates remains largely unaffected within the temperature range between 30° C. and 200° C. Temperature-dependent dielectric spectra further demonstrate that P6, boasting the highest T_{g}, exhibits superior stability in its dielectric properties across all testing temperatures. Comparative analysis of tan δ and k as a function of temperature for polysulfate P6, against other leading capacitor-grade polymer films such as BOPP, PEN, PEEK, PEI, FPE, Kapton PI, and Upilex-S PI was performed at 10+Hz, the critical frequency for common power conditioning applications. P6 stood out for its exceptionally low tan δ (≤0.2% from 30° C. to 275° C.), which is comparable to BOPP, known for its minimal dielectric loss due to its non-polar nature. Additionally, the k of P6 remains exceedingly stable, ranging from 3.37 to 3.39 from 30 to 250° C. with a temperature coefficient (C_{T}) of 0.013% ° C.⁻¹. This stability is superior to other high-T_{g} commercial alternatives and advanced composites such as the c-BCB/BN nanosheet nanocomposite which has a C_{T} of ˜0.024% ° C.⁻¹ over the same temperature range (c-BCB: cross-linked divinyltetramethyldisiloxane bis(benzocyclobutene)).^{[59]}

In addition to temperature stability, the absolute value of dielectric constant (k) significantly influences energy density^{[7, 60-62]}. Developing polymers with both a high k^{[8, 63]} and a high dielectric breakdown strength (E_{b}) is desirable, given their crucial role in determining the maximum U_{d} in linear dielectric materials, as described by the equation: U_{d}=0.5ε₀kE_{b}², where ε₀ represents the permittivity of free space. In this study, polysulfates P1-P6 exhibit varied k values ranging from 3.2 to 3.8 (at 10 kHz and room temperature). Among them, P1, P3, P4 and P6, feature a similar rigid and symmetrical main-chain structure depicted below, display comparable k values in the range of 3.35˜3.55. Polysulfate P5 displays the lowest k value of 3.2 in the series, despite having a similar main-chain structure. This variation is attributed to the presence of bulky bromide groups, which increase the free volume of the polymer and consequently reduce the k value^{[7]}. On the other hand, polysulfate P2, bearing a more polar and non-symmetrical ester group in its repeat unit, shows the highest k value of 3.8, consistent with the increased dipole moment.

Electrical conduction in dielectric materials can be affected by various mechanisms such as Schottky emission, Ohmic conduction, space-charge-limited current conduction (SCLC), Poole-Frenkel emission, and hopping conduction^{[10-61]}. Segmented fittings suggest that the conduction behavior in polysulfates P4-P6 is primarily dominated by a transport-limited hopping process in the higher field region (≥200 MV m⁻¹), while under electric fields lower than 100 MV m⁻¹. SCLC process (with incomplete occupation of trap states) appears to be the key mechanism. Analysis of the current density-electric field (J-E) relationship, was conducted by fitting the data to the hopping conduction equation (see Methods), which revealed comparable hopping distances (λ) in the range between 1.11 and 1.17 nm for these polysulfates. As λ correlates with the population density of the trap sites, such consistency aligns with previous observations that, for dielectric polymers with an adequately large bandgap (E_{g}>3.3 eV), the trap density becomes irrelevant with the increasing E_{g} values^{[29]}. Across the investigated electric field range, the J of the polymers follows the order of P4>P5>P6. P6 displays the lowest current density, nearly an order of magnitude lower than that of P4 (e.g., 2.71×10⁻⁸ A cm⁻² for P4 versus 3.72×10⁻⁹ A cm⁻² for P6, measured at 200° C. and 200 MV m⁻¹). Given that current leakage is a key mechanism of high-field loss in dielectric materials, the smallest J observed in P6 at elevated temperatures and high electric fields is in accordance with its superior energy density and efficiency compared to the other polysulfates.

The E_{b} of polysulfates P4-P6 at various temperatures was analyzed using a two-parameter Weibull statistical model (see Methods) and compared against the previously reported polysulfates P1-P3 ^{[36]}. All breakdown measurements were conducted on at least 10 gold-electrode-coated devices for each polysulfate film. The high-T_{g} polysulfates P4-P6 show high Weibull E_{b} along with high β values over 10 at 200° C. a temperature at which P1-P3 fail to function reliably, with P6 exhibiting an outstanding breakdown strength of 695 MV m⁻¹ and a β of 15.36 at 200° C. By generating a temperature-E_{b} plot, it can be observed that all polysulfates deliver a significant Weibull E_{b} over 650 MV m⁻¹ at room temperature, while at elevated temperatures, varying degrees of reduction in E_{b} are observed. Among these, polysulfate P6 shows exceptional resilience, with only a 5.53% decrease in Weibull E_{b} from 25° C. to 200° C. In contrast, the lower-T_{g} polysulfates P1-P3 exhibit more substantial decreases. i.e., a 33% reduction from 25° C. to 175° C. for P3 and 44% from 25° C. to 125° C. for P1, limiting their operational stability across a broad temperature range.

Dielectric breakdown is known as a complex process influenced by the electronic, thermal, and mechanical properties of polymers^{[31, 64, 65}]. At room temperature, polusulfates P2-P6 exhibit similar Weibull E_{b} values around 720˜740 MV m⁻¹. Even when excluding the influence of temperature, it is fundamentally challenging to correlate the Web with a single physical variable. The complexity increases with temperature-dependent dielectric breakdown, due to thermally-stimulated charge transport processes and changes in free volume at elevated temperatures. Even at operating temperatures below T_{g}, there is a significant rise in leakage current that accelerates the propagation of breakdown channels, thereby reducing E_{b}. In this study, despite the relatively smaller big of polysulfate P6, its highest T_{g} (˜307° C.) provides a substantial margin at the operational temperature of 200° C. Additionally, the lowest leakage current observed in polysulfate P6 supports its highest electrical insulation strength at 200° C.

### 4.2.4. Energy Storage Performance and Reliability

The discharged energy density (U_{d}) and charge-discharge efficiency (n) of polysulfate-based capacitors were derived from unipolar electric displacement-electric field (D-E) loops. At 600 MV m⁻¹ and 150° C., polysulfate P6 leads in energy storage capability, delivering a U_{d} of 5.96 J cm⁻³ and an of 95.80%, compared to 5.98 J cm⁻³ and 87.04% for P4, and 5.59 J cm⁻³ and 90.65% for P5. The marginally smaller U_{d} of P6 than P4 is attributed to its lower k, which linearly influences U_{d} under identical electric field conditions. Remarkably, at 200° C. P6 achieves a maximal U_{d} of 7.42 J cm⁻³ with a η of 84% at 700 MV m⁻¹ showcasing its superior breakdown strength and minimal leakage current at elevated temperatures. Such performance outcompetes commercial high-T_{g} dielectric polymers at η≥90%. P6 displays U_{d} values of 8.27 J cm⁻³ at 150° C. and 6.37 J cm⁻³ at 200° C. far exceeding the performance of the leading commercial polymer PEI (˜1.8 J cm⁻³ at 150° C. and ˜1.3 J cm⁻³ at 200° C.)^{[59]}. The high η indicates efficient energy utilization, essential for operational reliability and longer lifespan of capacitor devices. When comparing the U_{d} at above 90% n under 150° C. and 200° C. polysulfate P6 also stands out among the latest all-organic free-standing dielectric films.

Building upon the excellent baseline performance of polysulfate P6, further property optimization was explored through an organic/inorganic composite approach, given the proven effectiveness of inorganic nanomaterials in enhancing the energy storage properties of polymers. Two organic/inorganic composites were developed employing the most commonly used wide-bandgap Al₂O₃ as the reinforcing inorganic components: polysulfate P6 mixed with Al₂O₃ nanoparticle fillers (P6/Al₂O₃; NPs), and P6 coated with Al₂O₃ nanolayers via atomic layer deposition (ALD) (P6-Al₂O₃; coatings). Both P6/Al₂O₃; NPs and P6-Al₂O₃ coatings exhibited improved (Ja values of 9.28 J cm⁻³ and 9.51 J cm⁻³ at 150° C. and 90% η as well as 7.21 J cm⁻³ and 7.68 J cm⁻³ at 200° C. and 90% η respectively, outperforming the leading lab-developed organic/inorganic hybrid free-standing films, such as the state-of-the-art PEI/phosphotungstic acid subnanosheets (PWNSs) composite (U_{d} 7.2 J cm⁻³ at 200° C. and 90% η)^{[66]}.

Under an applied field of 200 MV m⁻¹, representative of typical operational conditions in power systems like hybrid EVs. P6 exhibits exceptionally low energy loss of less than 2% at 200° C. significantly outperforming the benchmark BOPP. Specifically. P6 tested at 200° C. displays a higher U_{d} and power density compared to BOPP tested at 105° C. (0.65 J cm⁻³ and 158.53 MW L⁻¹ for P6 versus 0.37 J cm⁻³ and 78.72 MW L⁻¹ for BOPP). Across different electric fields. i.e. at 200 and 400 MV m⁻¹. P6 displays remarkable stability in energy storage performance over 100.000 charge-discharge cycles at 200° C. with minimal variation within 0.4% and 0.5%, respectively. Additional tensile testing reveals that P6 exhibits a Young's modulus (˜1.1 GPa) comparable to commercial dielectric polymers such as FPE (˜1 GPa) and PEI (˜0.8 GPa) [59], supporting its use in flexible thin film capacitors. To verify this, a large area, free-standing film of P6 was produced through solution casting and subsequently subjected to electrical testing. The high consistency observed in the shape of D-E loops, U_{d}, and η across ten distinct regions of the film is demonstrative of the film's uniformity and high quality. Such validations underscore the excellent operational reliability of P6, establishing it as a superior choice for electrification applications under extreme conditions.

Accordingly, the exceptional potential of readily accessible polysulfates has been elucidated, marking a new frontier in the realm of electrically insulating and heat-resistant polymers tailored for the advanced demands of modern electrification challenges. Screenings of polysulfates' backbone structures, which encompass a diverse range of electronic, dielectric, and thermal properties, were conducted. This approach facilitated grouped comparisons and quantitative assessments, shedding light on the influence of specific structural motifs on key proxy performance indicators such as bandgap and glass transition temperature for sulfate-linked polymers. The specific polysulfate P6, featuring a 9,9-di(naphthalene)-fluorene core, demonstrates exceptional thermal resilience with a remarkable glass transition temperature, alongside a significant bandgap and notable dielectric constant. The capacitors fabricated from these films showcase superior dielectric stability across a broad temperature spectrum up to 275° C. These films further demonstrate exceptional breakdown strength and achieve a record-high discharged energy density at 90% efficiency when tested under 200° C. Rigorous reliability assessments underscore the superior quality and durability of these polymer film devices, establishing their suitability for integration into lightweight, compact, and integrated energy storage systems capable of withstanding extreme thermal and electrical stress. The results obtained from this optimization of dielectric polysulfate polymers sets a new record for the optimal performance of polymeric dielectric films in high-temperature applications.

### 4.3. Experimental Details

All reactions were conducted under a nitrogen atmosphere with anhydrous solvents, unless otherwise stated. Extra dry solvents over molecular sieves were purchased from Aldrich or Acros Organics, including acetonitrile (CH₃CN), tetrahydrofuran (THF), dimethylformamide (DMF), and N-methyl-2-pyrrolidone (NMP). All the starting materials used in this study are commercially available. The extent of the reaction was monitored by thin-layer chromatography (TLC), performed on 250 μm silica gel G plates with F254 indicator. The TLC plates were visualized by ultraviolet light (254 nm) and treated with potassium permanganate or ceric ammonium sulfate or p-anisaldehyde stain followed by gentle heating.

### 4.3.1. Abbreviations

Commonly used abbreviations include: acetyl (Ac), azo-bis-isobutyrylnitrile (AIBN), atmospheres (Atm), 9-borabicyclo[3.3.1]nonane (9-BBN or BBN), tert-butoxycarbonyl (Boc), di-tert-butyl pyrocarbonate or boc anhydride (BOC₂O), benzyl (Bn), butyl (Bu), Chemical Abstracts Registration Number (CASRN), benzyloxycarbonyl (CBZ or Z), carbonyl diimidazole (CDI), 1,4-diazabicyclo[2.2.2]octane (DABCO), diethylaminosulfurtrifluoride (DAST), dibenzylideneacetone (dba), 1,5-diazabicyclo[4.3.0]non-5-ene (DBN), 1,8-diazabicyclo[5.4.0]undec-7-ene (DBU), N,N′-dicyclohexylcarbodiimide (DCC), 1,2-dichloroethane (DCE), dichloromethane (DCM), diethyl azodicarboxylate (DEAD), di-iso-propylazodicarboxylate (DIAD), di-iso-butylaluminumhydride (DIBAL or DIBAL-H), 1,3-Diisopropylcarbodiimide (DIC), di-iso-propylethylamine (DIPEA), N,N-dimethyl acetamide (DMA), 4-N,N-dimethylaminopyridine (DMAP), N,N-dimethylformamide (DMF), dimethyl sulfoxide (DMSO), 1,1′-bis-(diphenylphosphino)ethane (dppe), 1,1′-bis-(diphenylphosphino)ferrocene (dppf), 1-(3-dimethylaminopropyl)-3-ethylcarbodiimide hydrochloride (EDCI), ethyl (Et), ethyl acetate (EtOAc), ethanol (EtOH), 2-ethoxy-2H-quinoline-1-carboxylic acid ethyl ester (EEDQ), diethyl ether (Et₂O), 0-(7-azabenzotriazole-1-yl)-N, N,N′N′-tetramethyluronium hexafluorophosphate acetic acid (HATU), acetic acid (HOAc), 1-N-hydroxybenzotriazole (HOBt), high pressure liquid chromatography (HPLC), iso-propanol (IPA), lithium hexamethyl disilazane (LiHMDS), methanol (MeOH), melting point (mp), MeSO₂— (mesyl or Ms), methyl (Me), acetonitrile (MeCN), m-chloroperbenzoic acid (MCPBA), mass spectrum (MS), methyl t-butyl ether (MTBE), N-bromosuccinimide (NBS), N-carboxyanhydride (NCA), N-chlorosuccinimide (NCS), N-methylmorpholine (NMM), N-methylpyrrolidone (NMP), pyridinium chlorochromate (PCC), pyridinium dichromate (PDC), phenyl (Ph), propyl (Pr), iso-propyl (i-Pr), pounds per square inch (psi), pyridine (pyr), room temperature (rt or RT), tert-butyldimethylsilyl or t-BuMe₂Si (TBDMS), triethylamine (TEA or Et₃N), 2,2,6,6-tetramethylpiperidine 1-oxyl (TEMPO), triflate or CF₃SO₂O— (OTf), trifluoroacetic acid (TFA), 1,1′-bis-2,2,6,6-tetramethylheptane-2,6-dione (TMHD), 0-benzotriazol-1-yl-N,N,N′,N′-tetramethyluronium tetrafluoroborate (TBTU), thin layer chromatography (TLC), tetrahydrofuran (THF), trimethylsilyl or Me₃Si (TMS), p-toluenesulfonic acid monohydrate (TsOH or pTsOH), 4-Me-C₆H₄SO₂— or tosyl (Ts), N-urethane-N-carboxyanhydride (UNCA), 2-tert-Butylimino-2-diethylamino-1,3-dimethyl perhydro-1,3,2-diazaphosphorine (BEMP), TBS=tert-Butyldimethylsilyl (TBS), and sulfuryl fluoride (SO₂F2).

### 4.3.2. Synthesis of Polysulfate P4

### Preparation of 3′,6′-bis((tert-butyldimethylsilyl)oxy)spiro[fluorene-9,9′-xanthene](P4-A)

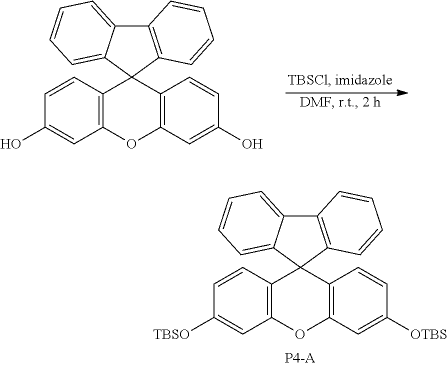 [SMILES: Oc1ccc2c(c1)Oc1cc(O)ccc1C21c2ccccc2-c2ccccc21 ; "DMF, r.t., 2 h" ; CC(C)(C)[Si](C)(C)Oc1ccc2c(c1)Oc1cc(O[Si](C)(C)C(C)(C)C)ccc1C21c2ccccc2-c2ccccc21]

Spiro[fluorene-9,9′-xanthene]-3′,6′-diol (1.00 g, 2.75 mmol, 1.00 eq.), TBSCl (1.24 g, 8.25 mmol, 3.00 eq.), and imidazole (0.74 g, 11.0 mmol, 4.00 eq.) were added to a 10 mL flask. Then DMF (3 mL) was added via a syringe. The mixture was stirred at room temperature for 2 h, and monitored by TLC. After completion, water (20 mL) was added, the resultant mixture was extracted with ethyl acetate (3×15 mL), and the combined organic phases were washed with brine (20 mL). The solution was further dried over anhydrous Na₂SO₄ and filtered. The solvent was evaporated under vacuum, and the residue was purified by flash column chromatography (0-10% EtOAc in n-hexane) to give P4-A (1.41 g, 87%) as a white solid. m.p. 179° C. ¹H NMR (600 MHz, CDCl₃): δ 7.77 (d, J=7.6 Hz, 2H), 7.35 (td, J=7.5, 1.1 Hz, 2H), 7.21 (td, J=7.5, 1.0 Hz, 2H), 7.16 (d, J=7.6 Hz, 2H), 6.69 (d, J=2.4 Hz, 2H), 6.28 (dd, J=8.6, 2.4 Hz, 2H), 6.24 (d, J=8.6 Hz, 2H), 0.97 (s, 18H), 0.20 (s, 12H). ¹³C NMR (151 Hz, CDCl₃): δ 155.52, 155.42, 152.06, 139.69, 128.66, 128.40, 127.71, 125.82, 119.92, 117.85, 115.84, 107.73, 53.67, 25.77, 18.29, −4.26. HR-APCI-MS m/z 593.2925 [M+H]⁺, calcd. for C₃₇H₄₅O₃Si₂⁺: 593.2902.

### Preparation of spiro[fluorene-9,9′-xanthene]-3′,6′-diyl bis(sulfurofluoridate) (P4-B)

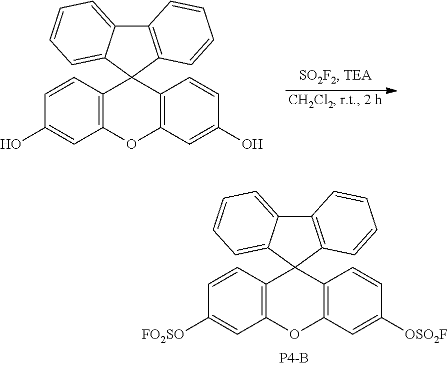

To a stirred solution of spiro[fluorene-9,9′-xanthene]-3′,6′-diol (1.00 g, 2.75 mmol, 1.00 eq.) in DCM (14 mL) was added triethylamine (1.14 mL, 0.83 g, 8.25 mmol, 3.00 eq.). The flask was then degassed and re-charged with SO₂F₂(gas) via a needle attached to a balloon. The mixture was stirred at room temperature for 2 h followed by the removal of solvent under vacuum. Water (20 mL) was added to the crude residue, and the resultant mixture was extracted with ethyl acetate (3×15 mL). The combined organic phases were washed with brine (20 mL), dried over anhydrous Na₂SO₄, and filtered. The solvent was evaporated under vacuum, and the residue was purified by flash column chromatography (0-10% EtOAc in n-hexane) to give P4-B (1.38 g, 95%) as a white solid. m.p. 204° C. ¹H NMR (600 MHz, CDCl₃): δ 7.84 (d, J=7.6 Hz, 2H), 7.44 (td, J=7.6, 0.9 Hz, 2H), 7.31-7.25 (m, 4H), 7.15 (d, J=7.6 Hz, 2H), 6.81 (dd, J=8.7, 2.5 Hz, 2H), 6.52 (d, J=8.8 Hz, 2H).¹³C NMR (151 Hz, CDCl₃): δ 153.83, 151.57, 149.12, 139.64, 130.12, 129.01, 128.86, 125.74, 125.54, 120.55, 116.63, 109.98, 53.63. ¹⁹F NMR (376 MHz, CDCl₃): δ 35.47 (s). HR-APCI-MS m/z 528.0149 [M]⁺, calcd. for C₂₅H₁₄F₂O₇S₂⁺: 528.0144.

### Preparation of Polysulfate P4 (Polycondensation Procedure)

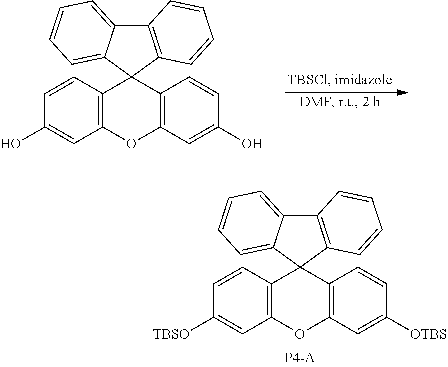 [SMILES: Oc1ccc2c(c1)Oc1cc(O)ccc1C21c2ccccc2-c2ccccc21 ; "DMF, r.t., 2 h" ; CC(C)(C)[Si](C)(C)Oc1ccc2c(c1)Oc1cc(O[Si](C)(C)C(C)(C)C)ccc1C21c2ccccc2-c2ccccc21]

To a flame-dried 20 mL vial equipped with a stir bar was added monomer P4-A (0.59 g, 1.00 mmol, 1.00 eq.), monomer P4-B (0.53 g, 1.00 mmol, 1.00 eq.) and NMP (1 mL). The container was sealed and degassed overnight and refilled with N₂ and placed into a pre-heated 130° C. heating block. Catalyst BEMP (3 μL) was added via a microsyringe. The reaction was then allowed to stir for 24 hours at 130° C. Thereafter, another 2 mL of DMF was added to dissolve the polymer at this temperature. The resulting DMF solution was slowly injected into 50 mL of methanol under vigorous stirring. Polymers crashed out as white balls/strips in methanol. The product was collected via filtration, re-dissolved in DMF, and underwent precipitation and filtration once more for purification. The final polymer product was dried at 60° C. for 3 hours in vacuo (2.0 torr) to yield an off-white solid (0.78 g, 92%). ¹H NMR (600 MHz, THF-d₈): δ 7.87 (d, J=6.9 Hz, 2H), 7.33 (m, 4H), 7.13 (m, 4H), 6.76 (d, J=7.5 Hz, 2H), 6.43 (d, J=8.3 Hz, 2H).¹³C NMR (151 Hz, THF-d₈): δ 155.20, 152.44, 150.60, 140.58, 130.44, 129.54, 129.25, 126.37, 125.33, 121.08, 117.43, 110.54, 54.51. Molecular weight and polymer distribution were determined using GPC. Mₙ^{ps}=31.2 kDa, PDI=1.27.

### 4.3.3. Synthesis of Polysulfate P5

### Preparation of 4,4′-(2,7-dibromo-9H-fluorene-9,9-diyl)diphenol (P5-OH)

To a mixture of 2,7-dibromo-9H-fluoren-9-one (3.60 g, 10.6 mmol, 1.00 eq) and phenol (5.00 g, 66.6 mmol, 6.00 eq) in a 40 mL vial, was added MsOH (14 mL). The mixture was heated at 60° C. for 48 hours. The resulting liquid was poured into ice-water and the solid precipitate was collected by filtration. The solid was dried under vacuum for 5 hours to remove water, and then re-dissolved in EtOAc. The solution was injected into hexane for precipitation, and the resulting solid was collected by filtration to yield the desired product 4,4′-(2,7-dibromo-9H-fluorene-9,9-diyl)diphenol P5-OH (5.00 g, 93%) as an off-white solid. This high-purity product was used in the next step without further purification. m.p. 280-282° C. ¹H NMR (400 MHz, DMSO-d₆) δ 9.38 (brs, 2H), 7.86 (d, J=8.2 Hz, 2H), 7.54 (d, J=8.2 Hz, 2H), 7.45 (s, 2H), 6.85 (d, J=8.5 Hz, 4H), 6.62 (d, J=8.6 Hz, 4H). ¹³C NMR (151 MHz, 5% CD₃OD/95% CDCl₃) δ 159.67, 157.86, 141.73, 139.51, 134.48, 133.13, 132.98, 125.54, 119.08, 68.26. HR-APCI-MS m/z 505.9502 [M]⁺, calcd for C₂₅H₁₆Br₂O₂⁺: 505.9512.

### Preparation of (((2,7-dibromo-9H-fluorene-9,9-diyl)bis(4,1-phenylene))bis(oxy))bis(tert-butyldimethylsilane) (P5-A)

P5-OH (1.00 g, 2.00 mmol, 1.00 eq.) was dissolved in CH₂Cl₂ (20 mL) in a 100 mL flask. To this solution, imidazole (0.36 g, 5.20 mmol, 2.60 eq.) was added and the mixture was allowed to stir at room temperature for 10 min. Next, TBSCl (0.72 g, 4.80 mmol, 2.40 eq.) was added portion-wise and the resulting mixture was stirred for 24 hours at room temperature until complete consumption of the starting material. The reaction was quenched by adding 20 mL of water, and the aqueous layer was extracted with CH₂Cl₂ (3×10 mL). The organic layer was combined, dried over Na₂SO₄ and evaporated. The crude product was further purified by flash column chromatography on silica gel (0-15% EtOAc in n-hexane) to yield the title product P5-A as a white solid (1.10 g, 82% yield). m.p. 231-233° C. ¹H NMR (400 MHz, CDCl₃) δ 7.55 (d, J=8.5 Hz, 2H), 7.49-7.37 (m, 4H), 6.96 (d, J=8.6 Hz, 4H), 6.68 (d, J=8.6 Hz, 4H), 0.95 (s, 18H), 0.17 (s, 12H). ¹³C NMR (151 MHz, CDCl₃) δ 154.71, 153.77, 137.89, 137.01, 130.71, 129.36, 129.03, 121.74, 121.50, 119.75, 64.49, 25.64, 18.13, −4.37. HR-APCI-MS m/z 734.1210 [M]⁺, calcd. for C₃₇H₄₄Br₂O₂Si₂⁺: 734.1421.

### Preparation of (2,7-dibromo-9H-fluorene-9,9-diyl)bis(4,1-phenylene) bis(sulfurofluoridate) (P5-B)

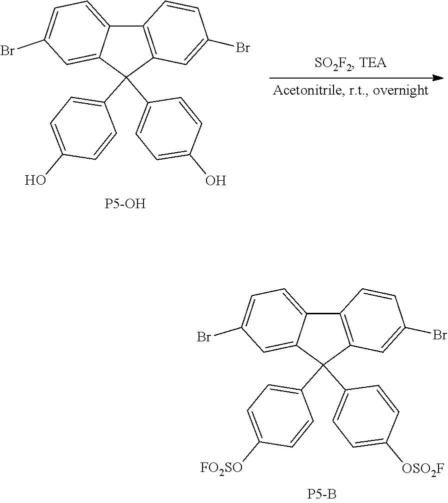

To a stirred solution of P5-OH (1.00 g, 2.00 mmol, 1.00 eq.) in acetonitrile (20 mL) in a 100 mL flask, was added triethylamine (0.84 mL, 6.00 mmol, 3.00 eq.). This reaction container was sealed, degassed, and recharged with SO₂F₂(gas) via a needle attached to a balloon. The reaction was vigorously stirred overnight at room temperature before being quenched with 20 mL of water. Ethyl acetate (3×15 mL) was added for extraction. The organic layer was separated, dried over MgSO₄, and evaporated. The residue was then purified by flash column chromatography on silica gel (0-30% EtOAc in n-hexane) to give the desired product P5-B as a white solid (1.20 g, 82% yield). m.p. 213-215° C. ¹H NMR (400 MHz, CDCl₃) δ 7.63 (d, J=7.7 Hz, 2H), 7.55 (d, J=7.6 Hz, 2H), 7.42 (s, 2H), 7.30-7.16 (m, 8H). ¹³C NMR (151 MHz, CDCl₃) δ 151.27, 149.24, 144.57, 137.98, 131.93, 129.87, 129.08, 122.41, 122.09, 121.34, 64.52. ¹⁹F NMR (376 MHz, CDCl₃) δ 38.08 (s). HR-APCI-MS m/z 669.8570 [M]⁺, calcd. for C₂₅H₁₄Br₂F₂O₆S₂⁺: 669.8561.

### Preparation of Polysulfate P5.

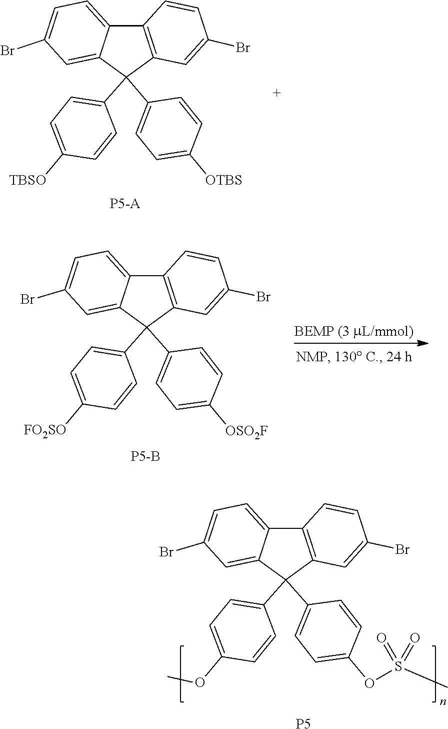

Polysulfate P5 was synthesized following the polycondensation procedure for the preparation of polysulfate P4, however using monomers P5-A (0.74 g, 1.00 mmol, 1.00 eq) and P5-B (0.74 g, 1.00 mmol, 1.00 eq) and BEMP (3 μL) as the catalyst to yield P5 as a white solid (1.05 g, 92%). ¹H NMR (600 MHz, DMSO-d₆) δ 8.00 (d, J=8.2 Hz, 2H), 7.75 (d, J=1.8 Hz, 2H), 7.69 (dd, J=8.2, 1.8 Hz, 2H), 7.57-7.52 (m, 4H), 7.39-7.34 (m, 4H).^{1 13}C NMR (151 MHz, DMSO-d₆) δ 151.31, 148.76, 144.84, 137.77, 131.76, 130.09, 128.77, 123.24, 121.76, 121.46, 64.28. The molecular weight and polydispersity were determined using GPC. Mₙ^{ps}=22.6 kDa, PDI=1.35.

### 4.3.4. Synthesis of Polysulfate P6

### Preparation of (((9H-fluorene-9,9-diyl)bis(naphthalene-6,2-diyl))bis(oxy))bis(tert-butyldimethylsilane) (P6-A)

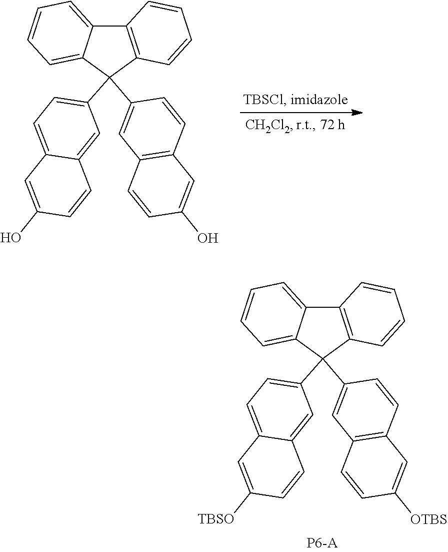 [SMILES: Oc1ccc2cc(C3(c4ccc5cc(O)ccc5c4)c4ccccc4-c4ccccc43)ccc2c1 ; CC(C)(C)[Si](C)(C)Oc1ccc2cc(C3(c4ccc5cc(O[Si](C)(C)C(C)(C)C)ccc5c4)c4ccccc4-c4ccccc43)ccc2c1]

To a solution containing 6,6′-(9H-fluorene-9,9-diyl)bis(naphthalen-2-ol) (2.70 g, 6.00 mmol, 1.00 eq) in CH₂Cl₂ (50 mL) was added imidazole (1.06 g, 15.6 mmol, 2.60 eq). After stirring for 10 minutes, TBSCl (0.72 g, 4.80 mmol, 2.40 eq.) was added portion-wise. The resulting mixture was stirred for 72 hours at room temperature until the starting material was completely consumed. Water (20 mL) was added, and the aqueous layer was extracted with CH₂Cl₂ (3×10 mL). The organic layer was combined, dried over Na₂SO₄ and evaporated. The crude product was further purified by flash column chromatography on silica gel (0-25% EtOAc in n-hexane) to yield product P6-A as a white solid (2.80 g, 84%). m.p. 232-233° C. ¹H NMR (400 MHz, CDCl₃) δ 7.80 (d, J=7.5 Hz, 2H), 7.57 (d, J=8.7 Hz, 2H), 7.52-7.47 (m, 6H), 7.37 (ddd, J=7.5, 4.3, 1.6 Hz, 4H), 7.28 (dd, J=7.6, 1.2 Hz, 2H), 7.12 (d, J=2.4 Hz, 2H), 6.98 (dd, J=8.8, 2.4 Hz, 2H), 0.98 (s, 18H), 0.20 (s, 12H). ¹³C NMR (151 MHz, CDCl₃) δ 150.12, 147.79, 144.67, 140.46, 132.51, 132.42, 131.07, 128.85, 128.55, 128.31, 128.24, 126.26, 126.22, 120.80, 119.47, 118.65, 65.61. HR-APCI-MS m/z 678.3346 [M]⁺, calcd for C₄₅H₅₀O₂Si₂⁺: 678.3344.

### Preparation of (9H-fluorene-9,9-diyl)bis(naphthalene-6,2-diyl) bis(sulfurofluoridate) (P6-B)

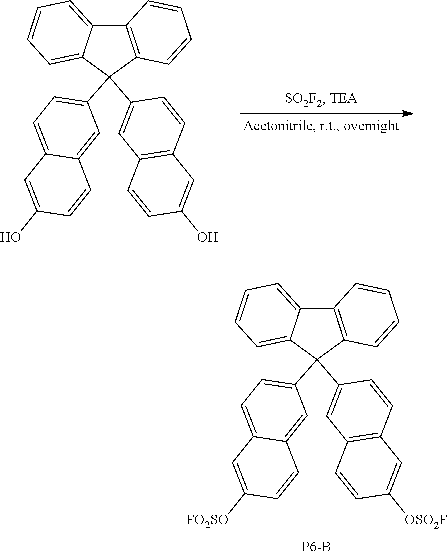

To a stirred solution of 6,6′-(9H-fluorene-9,9-diyl)bis(naphthalen-2-ol) (2.70 g, 6.00 mmol, 1.00 eq.) in acetonitrile (20 mL) in a 100 mL flask was added triethylamine (0.84 mL, 6.00 mmol, 3.00 eq.). This reaction container was sealed, degassed, and recharged with sulfuryl fluoride gas via a needle attached to a balloon. The reaction was vigorously stirred overnight at room temperature before being quenched with 20 mL of water. Ethyl acetate (3×15 mL) was added for extraction. The organic layer was separated, dried over MgSO₄, and evaporated. The residue was then purified by flash column chromatography on silica gel (0-40% EtOAc in n-hexane) to give the desired product P6-B as a white solid (3.40 g, 76% yield). m.p. 132-133° C. ¹H NMR (400 MHz, CDCl₃) δ 7.89-7.82 (m, 2H), 7.80 (d, J=8.7 Hz, 2H), 7.77-7.72 (m, 4H), 7.64 (d, J=1.9 Hz, 2H), 7.52 (dd, J=8.7, 1.9 Hz, 2H), 7.48-7.39 (m, 4H), 7.36 (dd, J=9.0, 2.5 Hz, 2H), 7.31 (td, J=7.5, 1.2 Hz, 2H). ¹³C NMR (151 MHz, CDCl₃) δ 153.64, 151.36, 141.10, 140.40, 133.60, 129.56, 129.08, 127.88, 127.67, 127.62, 126.95, 126.44, 126.00, 122.28, 120.41, 114.78, 65.53, 25.88, 18.42, −4.20. HR-APCI-MS m/z 614.0667 [M]⁺, calcd for C₃₃H₂₀F₂O₆S₂⁺: 614.0664.

### Preparation of Polysulfate P6

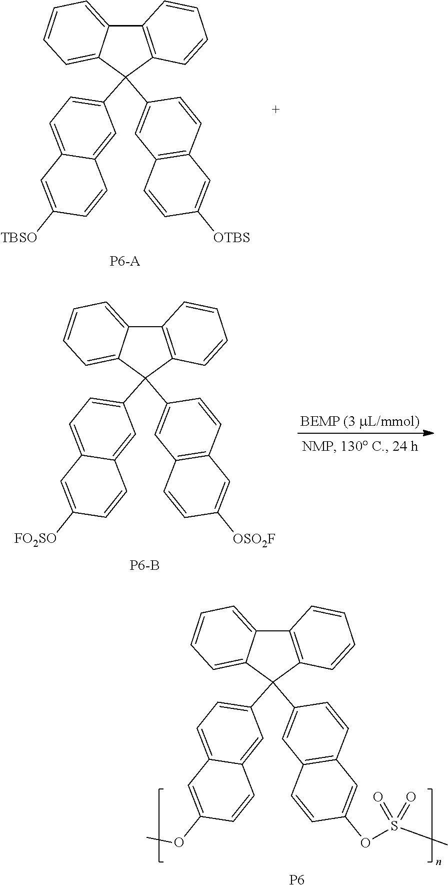

Polysulfate P6 was synthesized following the polycondensation procedure for the preparation of polysulfate P4, however using monomers P6-A (0.68 g, 1.00 mmol, 1.00 eq.) and P6-B (0.62 g, 1.00 mmol, 1.00 eq.) and BEMP (3 μL) as the catalyst to yield P6 as a white solid (0.92 g, 90% yield). ¹H NMR (600 MHz, DMSO-d₆) δ 8.08-7.74 (m, 8H), 7.71-7.60 (m, 2H), 7.59-7.52 (m, 2H), 7.50-7.33 (m, 6H), 7.32-7.23 (m, 2H). ¹³C NMR (151 MHz, DMSO-d₆) δ 149.68, 147.46, 143.94, 139.69, 131.96, 131.50, 130.75, 128.39, 128.07, 126.14, 125.47, 120.78, 120.02, 118.22, 65.02. The molecular weight and polydispersity were determined using GPC. Mₙ^{ps}=22.3 kDa, PDI=1.43.

### 4.3.5. Polymeric Film Preparation

Polysulfates P4-P6 were dissolved in DMF to yield a clear solution with a concentration of 15 mg mL⁻¹ under magnetic mechanical stirring overnight at room temperature. The obtained polymer/DMF solutions were cast on clean glass slides at room temperature, and kept in an air-circulating oven at 65° C. for 12 h to evaporate the solvent. Afterward, the resultant polymer films were peeled off in deionized water and placed in a vacuum oven at 180° C. for 12 h to remove water and solvent residuals. The typical thickness of the free-standing polysulfate films is 2-5 m. Other free-standing polymer films of Upilex-S PI, Kapton PI, BOPP, PEEK, PEN, FPE and PEI were obtained from PolyK Technologies, LLC., USA.

Al₂O₃ coatings were deposited on both sides of the polysulfate film using plasma-enhanced atomic layer deposition (ALD) at 40° C. (FLEXAL, Oxford Instruments). The polymer films were suspended using a custom steel frame to ensure equal depositions on both sides. At each cycle, trimethylaluminum (TMA) is dosed for 20 ms, followed by TMA purge using Ar/O₂ mixture for 4 s and plasma dose for 2 s. All processes were conducted at 15 mTorr. The deposition rate was controlled at 0.139 nm per cycle. The thickness of the coated Al₂O₃ nanolayers was measured to be ˜5.7 nm by using an ellipsometer along with a clean Si wafer as a reference. Al₂O₃ nanoparticles (y phase, ˜15 nm diameter, XFNANO), with a volume ratio of 5 vol % to the polymer matrix, were dispersed in the pre-prepared polysulfate/DMF solution via ultrasonication for 30 min. The obtained polymer/DMF solutions were cast on clean glass slides at room temperature, and kept in an air-circulating oven at 65° C. for 12 h to evaporate the solvent. Afterward, the resultant polymer films were peeled off in deionized water and placed in a vacuum oven at 180° C. for 12 h to remove water and solvent residuals. The typical thickness of the free-standing polysulfate/Al₂O₃ composite films is 2-5 μm.

For all the dielectric and electrical measurements, both sides of the polymeric films were coated with gold electrodes using a magnetron sputter (Q150R, Quorum) with a thickness of 20 nm and an area of 1 mm² for dielectric breakdown and electric displacement-electric field (D-E) loop measurements, 4 mm² for charge-discharging cyclic measurements, and 28.26 mm² for dielectric spectroscopy and leakage current measurements.

For flash DSC measurements, the testing specimen was obtained by drop casting the solution onto a silicon wafer. After completely drying, the film was trimmed using a scalpel to cover the heating area on the sample side with a size of 0.5×0.5 mm. After melt-on (a heating ramp from room temperature to erase previous thermal history) procedure, the testing specimen was stuck on top of the heating area to prevent any possible displacement during the measuring process.

### 4.3.6. Structural Characterization

Flash chromatography was performed on silica gel using Teledyne ISCO CombiFlash® R_{f}⁺ Lumen system with disposable BUCHI flash columns (40-63 μm, 230-400 mesh). High-resolution mass spectra (HRMS) were performed on an Agilent 6546 LC/QTOF mass spectrometer using APCI as an ion source. Melting points were measured on a Stuart SMP50 Automatic Digital Melting Point Apparatus and were uncorrected. ¹H, ¹³C, and ¹⁹F NMR spectra were recorded on Bruker DRX-600, Bruker AMX-400, and JEOL-400 instruments. The Gel permeation chromatography (GPC) for polymer molecular weight analysis was carried out with Waters system (1515 pump, 2414 refractive index detector and 2489 UV detector) and Shodex GPC LF-804 column eluted with THF (HPLC grade, Sigma-Aldrich). The flow rate was 1.0 mL min⁻¹ and the temperature of the column was maintained at 35° C. Samples were diluted in 0.001-0.005 wt % by THF and filtered with a 0.20 m PTFE filter before injection into the GPC. The duration is 45 minutes.

The traditional differential scanning calorimetry (DSC) analysis was carried out on TA Q200 under nitrogen using aluminum pans with a heating rate of 10° C. min⁻¹. The glass transition temperature (T_{g}) is defined as the midpoint temperature of a step in the baseline of the DSC curve. A Mettler-Toledo Flash differential scanning calorimeter (Flash DSC 2+) was used for glass transition temperature measurements. The ultra-fast standard chip with heating and cooling rates up to 4000 K s⁻¹ was employed in Flash DSC. The testing films were held 5 s above T_{g} to erase the previous thermal history and then cooled at 1000 K s⁻¹, where T_{g} was obtained by the subsequent heating scans at heating rates of 1000 K s⁻¹. All measurements were done under nitrogen gas with a flow rate of 60 ml min⁻¹ at ambient gas pressure. The thermal gravimetric analysis (TGA) was carried out on TGA-MS Q5000 (TA Instruments) under nitrogen using aluminum pans with a heating rate of 10° C. min⁻¹ from 25° C. to 600° C. All polymer samples were treated in a vacuum oven at 105° C. for 30 min before DSC and TGA measurements. UV-vis absorption spectra of the polymer films were obtained on an Agilent Cary 5000 UV-Vis-NIR spectrometer. The optical transmittance of the samples was measured in the wavelength range 250-600 nm. DMA measurements were performed on a TA Q850 DMA (TA Instrument). Film samples (20-30 mm in length, 5-6 mm in width) were loaded to the film tensile mode clamp with specimen gauge lengths 8-12 mm. The uniaxial tensile measurements were performed in a strain-rate mode at 25° C. and 200° C. with a strain rate of 0.2 mm min⁻¹ to get the elastic modulus of the materials.

### 4.3.7. Electrical Characterization

Dielectric spectra of the polymeric film samples were acquired over wide frequency and temperature ranges using a Hewlett Packard 4284A LCR meter. The samples in a dielectric test fixture were placed in a temperature chamber (EC1A, Sun Electronic Systems, Inc.), where the temperature-dependent dielectric spectra were acquired between 30° C. and 275° C. The temperature coefficient C_{T} of the k is obtained from Equation (1)

$${C}_{T} = \vert \frac{{k}_{i} - {k}_{0}}{{T}_{i} - {T}_{0}} \vert \times 100 \% \qquad ( 1 )$$

where kᵢ is the k at temperature Tᵢ, and k₀ is the k at T₀ (i.e., 30° C.). Dielectric breakdown strengths of the polymeric film samples were measured using a Trek 610D instrument amplifier as the voltage source based on an electrostatic pull-down method, where a DC voltage ramp of 500 V s⁻¹ was applied to the film samples until dielectric failure. The breakdown strength was evaluated by performing a two-parameter Weibull distribution analysis (Equation (2)) on at least 10 samples

$$P ( {E}_{b} ) = 1 - exp ( - {( \frac{{E}_{b}}{α} )}^{β} ) \qquad ( 2 )$$

where P(E_{b}) is the probability of breakdown at a certain electric field strength, E_{b} is the measured dielectric breakdown field, a is the Weibull breakdown strength (i.e., Weibull E_{b}) which is associated with the electric field at a 63.2% probability of breakdown, f is the shape parameter which represents the dispersion degree of the data. D-E loops of the polymeric film samples were measured under varied applied electric fields using a modified Sawyer-Tower circuit, which is integrated with a PK-CPE1801 high-voltage test system (PolyK Technologies, LLC). The voltages with a unipolar triangular waveform were applied at a frequency of 100 Hz. The charging/discharging cyclic measurements were performed by collecting D-E loops under a consecutive repeated electric field of 200 MV m⁻¹ based on the same high voltage test system using the Fatigue mode. For dielectric breakdown and D-E loop measurements, the samples were immersed in Galden HT-270 PFPE fluorinated fluid to avoid creeping discharge, and the temperature was controlled using a digital hot plate equipped with a thermal couple. Leakage current densities of the polymeric film samples were acquired under varied applied electric field strengths in a temperature chamber (EC1A, Sun Electronic Systems, Inc.), using a Keithley 6514 electrometer coupled with an external Trek 610D amplifier as the voltage source. According to the hopping conduction equation, leakage current density (J_{hopping}) is given as

$${J}_{hopping} ( E , T ) = 2 n e λ v \times exp ( - \frac{{W}_{a}}{{K}_{B} T} ) \times sinh ( \frac{λ e E}{2 {K}_{B} T} ) \qquad ( 3 )$$

where E is the applied electric field during current density measurement, n is the carrier concentration, λ is the hopping distance, v is the attempt-to-escape frequency, Wₐ is the activation energy, T is the temperature, e is the charge of the carriers, K_{B} is the Boltzmann's constant. Equation (3) can be simplified as

$${J}_{h o p p i n g} ( E ) = A * sinh ( B \times E ) \qquad ( 4 )$$

where A and B are two lumped parameters.

The T_{g} and k datasets were collected from PolyInfo, while the E_{g} dataset was collected from Polymer Genome^{[48]}. The data in PolyInfo were compiled from various literature reports by numerous researchers; the data in Polymer Genome were obtained through high-throughput computation using density functional theory, supplemented by experimentally measured properties sourced from literature and other data collections.

### 4.4. References

1. Meng, N., Ren, X., Santagiuliana, G., Ventura, L., Zhang, H., Wu, J., Yan, H., Reece, M. J. & Bilotti, E. Ultrahigh β-phase content poly(vinylidene fluoride) with relaxor-like ferroelectricity for high energy density capacitors. Nat. Commun. 10, 4535 (2019).
2. Tawade, B. V., Singh, M., Apata, I. E., Veerasamy, J., Pradhan, N., Karim, A., Douglas, J. F. & Raghavan, D. Polymer-grafted nanoparticles with variable grafting densities for high energy density polymeric nanocomposite dielectric capacitors. JACS Au 3, 5, 1365 (2023).
3. Wu, X., Chen, X., Zhang, Q. M. & Tan, D. Q. Advanced dielectric polymers for energy storage. Energy Storage Mater. 44, 29 (2022).
4. Zha, J.-W., Xiao, M., Wan, B., Wang, X., Dang, Z.-M. & Chen, G. Polymer dielectrics for high-temperature energy storage: constructing carrier traps. Prog. Mater. Sci. 140, 101208 (2023).
5. Luo, H., Zhou, X., Ellingford, C., Zhang, Y., Chen, S., Zhou, K., Zhang, D., Bowen, C. R. & Wan C. Interface design for high energy density polymer nanocomposites. Chem. Soc. Rev. 48, 4424 (2019).
6. Zhang, Q., Chen, X., Zhang, B., Zhang, T., Lu, W., Chen, Z., Liu, Z., Kim, S. H., Donovan, B., Warzoha, R. J., Gomez, E. D., Bernholc, J. & Zhang, Q. M. High-temperature polymers with record-high breakdown strength enabled by rationally designed chain-packing behavior in blends. Matter 4, 2448 (2021).
7. Chen, J., Pei, Z., Chai, B., Jiang, P., Ma, L., Zhu, L. & Huang, X. Engineering the dielectric constants of polymers: from molecular to mesoscopic scales. Adv. Mater. 2308670 (2024). https://doi.org/10.1002/adma.202308670
8. Wu, C., Deshmukh, A. A., Li, Z., Chen, L., Alamri, A., Wang, Y., Ramprasad, R., Sotzing, G. A. & Cao, Y. Flexible temperature-invariant polymer dielectrics with large bandgap. Adv. Mater. 32, 2000499. (2020).
9. Feng, Q.-K., Zhong, S.-L., Pei, J.-Y., Zhao, Y., Zhang, D.-L.; Liu, D.-F.; Zhang, Y.-X. & Dang, Z.-M. Recent progress and future prospects on all-organic polymer dielectrics for energy storage capacitors. Chem. Rev. 122, 3820 (2022).
10. Yang, M., Guo, M., Xu, E., Ren, W., Wang, D., Li, S., Zhang, S., Nan, C.-W. & Shen, Y. Polymer nanocomposite dielectrics for capacitive energy storage. Nat. Nanotechnol. 19, 588 (2024).
11. Liu, X.-J., Zheng, M.-S., Chen, G., Dang, Z.-M. & Zha, J. High-temperature polyimide dielectric materials for energy storage: theory, design, preparation and properties. Energy Environ. Sci., 2022, 15, 56-81
12. Song, J., Qin, H., Qin, S., Liu, M., Zhang, S., Chen, J., Zhang, Y., Wang, S., Li, Q., Dong, L. & Xiong, C. Alicyclic polyimides with large band gaps exhibit superior high-temperature capacitive energy storage. Mater. Horiz. 10, 2139 (2023).
13. Ren, W., Yang, M., Guo, M., Zhou, L., Pan, J., Xiao, Y., Xu, E., Nan, C.-W. & Shen, Y. Metallized stacked polymer film capacitors for high-temperature capacitive energy storage. Energy Storage Mater. 65, 103095 (2024).
14. Dong, J., Li, L., Niu, Y., Pan, Z., Pan, Y., Sun, L., Tan, L., Liu, Y., Xu, X., Guo, X., Wang, Q. & Wang, H. Scalable high-permittivity polyimide copolymer with ultrahigh high-temperature capacitive performance enabled by molecular engineering. Adv. Energy Mater. 14, 2303732 (2024).
15. Sanchez-Lengeling, B., & Aspuru-Guzik, A. Inverse molecular design using machine learning: Generative models for matter engineering. Science 361, 360 (2018).
16. Martin, T. B., & Audus, D. J. Emerging trends in machine learning: A polymer perspective. ACS Polym. Au 3, 239 (2023).
17. Ramprasad, R., Batra, R., Pilania, G., Mannodi-Kanakkithodi, A. & Kim, C. Machine learning in materials informatics: recent applications and prospects. npj Comput. Mater. 3, 54 (2017).
18. Kuenneth, C. & Ramprasad, R. polyBERT: a chemical language model to enable full machine-driven ultrafast polymer informatics. Nat. Commun. 14, 4099 (2023).
19. Liu, Y., Yang, Z., Yu, Z., Liu, Z., Liu, D., Lin, H., Li, M., Ma, S., Acdeev, M. & Shi, S. Generative artificial intelligence and its applications in materials science: Current situation and future perspectives. J. Materiomics, 9, 798 (2023).
20. Shen, Z.-H., Liu, H.-X., Shen, Y., Hu, J.-M., Chen, L.-Q. & Nan, C.-W. Machine learning in energy storage materials. Interdiscip. Mater. 1, 175 (2022).
21. Chen, L., Pilania, G., Batra, R., Huan, T. D., Kim, C., Kuenneth, C. & Ramprasad, R. Polymer informatics: Current status and critical next steps. Mater. Sci. Eng. R 144, 100595 (2021).
22. Dave, A., Mitchell, J., Kandasamy, K., Wang, H., Burke, S., Paria, B., Póczos, B., Whitacre, J. & Viswanathan, V. Autonomous discovery of battery electrolytes with robotic experimentation and machine learning. Cell Rep. Phys. Sci. 1, 12 (2020).
23. Boyd, P. G., Chidambaram, A., Garcia-Diez, E., Ireland, C. P., Daff, T. D., Bounds, R., Gladysiak, A., Schouwink, P., Moosavi, S. M., Maroto-Valer, M. M., Reimer, J. A., Navarro, J. A. R., Woo, T. K., Garcia, S., Stylianou, K. C. & Smit, B. Data-driven design of metal-organic frameworks for wet flue gas CO₂ capture. Nature 576, 253 (2019).
24. Kang, Y., Park, H., Smit, B. & Kim, J. A multi-modal pre-training transformer for universal transfer learning in metal-organic frameworks. Nat. Mach. Intell. 5, 309 (2023).
25. Luo, Y, Bag, S., Zaremba, O., Cierpka, A., Andreo, J., Wuttke, S., Friederich, P. & Tsotsalas, M. MOF synthesis prediction enabled by automatic data mining and machine learning. Angew. Chem. 134, e202200242(2022).
26. Rosen, A. S., Fung, V., Huck, P., O'Donnell, C. T., Horton, M. K., Truhlar, D. G., Persson, K. A., Notestein, J. M. & Snurr, R. O. High-throughput predictions of metal-organic framework electronic properties: theoretical challenges, graph neural networks, and data exploration. npj Comput. Mater. 8, 112 (2022).
27. Rao, Z., Tung, P.-Y., Xie, R., Wei, Y., Zhang, H., Ferrari, A., Klaver, T. P. C., Körmann, F., Sukumar, P. T., Silva, A. K. D., Chen, Y., Li, Z., Ponge, D., Neugebauer, J., Gutfleisch, O., Bauer, S. & Raabe, D. Machine learning-enabled high-entropy alloy discovery. Science 378, 78 (2022).
28. Yao, Y., Dong, Q., Brozena, A., Luo, J., Miao, J., Chi, M., Wang, C., Kevrekidis, I. G., Ren, Z. J., Greeley, J., Wang, G., Anapolsky, A. & Hu, L. High-entropy nanoparticles: Synthesis-structure-property relationships and data-driven discovery. Science 376, 6589 (2022).
29. Wang, R., Zhu, Y., Fu, J., Yang, M., Ran, Z., Li, J., Li, M., Hu, J., He, J. & Li, Q. Designing tailored combinations of structural units in polymer dielectrics for high-temperature capacitive energy storage. Nat. Commun. 14, 2406 (2023).
30. Tao, L., He, J., Munyaneza, N. E., Varshney, V., Chen, W., Liu, G. & Li, Y. Discovery of multi-functional polyimides through high-throughput screening using explainable machine learning. Chem. Eng. J. 465, 142949 (2023).
31. Wu, C., Chen, L., Deshmukh, A., Kamal, D., Li, Z., Shetty, P., Zhou, J., Sahu, H., Tran, H., Sotzing, G., Ramprasad, R. & Cao, Y. Dielectric polymers tolerant to electric field and temperature extremes: Integration of phenomenology, informatics, and experimental validation. ACS Appl. Mater. Interfaces 13, 53416 (2021).
32. Yang, C., Flynn, J. P. & Niu, J. Facile synthesis of sequence-regulated synthetic polymers using orthogonal SuFEx and CuAAC click reactions. Angew. Chem. Int. Ed. 57, 16194 (2018).
33. Geng, Z., Shin, J. J., Xi, Y. & Hawker, C. J. Click chemistry strategies for the accelerated synthesis of functional macromolecules. J. Polym. Sci. 59, 963 (2021).
34. Kolb, H. C., Finn, M. G. & Sharpless K. B. Click chemistry: diverse chemical function from a few good reactions. Angew. Chem. Int. Ed. 40, 2004 (2001).
35. Homer, J. A., Xu, L., Kayambu, N., Zheng, Q., Choi, E. J., Kim, B. M., Sharpless, K. B., Zuilhof, H., Dong, J. & Moses, J. E. Sulfur fluoride exchange. Nat. Rev. Methods Prim. 3, 58 (2023).
36. Li, H., Chang, B. S., Kim, H., Xie, Z., Lain6, A., Ma, L., Xu, T., Yang, C., Kwon, J., Shelton, S. W., Kilvansky, L. M., Altoé, V., Gao, B., Schwartzberg, A. M., Peng, Z., Ritchie, R. O., Xu, T., Salmeron, M., Ruiz, R., Sharpless, K. B., Wu, P. & Liu, Y. High-performing polysulfate dielectrics for electrostatic energy storage under harsh conditions. Joule 7, 95 (2023).
37. Gao, B., Zhang, L., Zheng, Q., Zhou, F., Klivansky, L. M., Lu, J., Liu, Y. & Sharpless, K. B. Bifluoride-catalysed sulfur (VI) fluoride exchange reaction for the synthesis of polysulfates and polysulfonates. Nat. Chem. 9, 1083 (2017).
38. Kim, H., Zhao, J., Bae, J., Klivansky, L. M., Dailing, E. A., Liu, Y., Cappiello, J. R., Sharpless, K. B. & Wu, P. Chain-growth sulfur (VI) fluoride exchange polycondensation: Molecular weight control and synthesis of degradable polysulfates. ACS Cent. Sci. 7, 1919 (2021).
39. Wang, H., Zhou, F., Ren, G., Zheng, Q., Chen, H., Gao, B., Klivansky, L., Liu, Y., Wu, B., Xu, Q., Lu, J., Sharpless, K. B. & Wu, P. SuFEx-based polysulfonate formation from ethenesulfonyl fluoride-amine adducts. Angew. Chem. Int. Ed. 56, 11203 (2017).
40. Tao, L., Varshney, V. & Li, Y. Benchmarking machine learning models for polymer informatics: an example of glass transition temperature. J. Chem. Inf Model. 61, 5395 (2021).
41. Liu, Y., Guo, B., Zou, X., Li, Y. & Shi, S. Machine learning assisted materials design and discovery for rechargeable batteries. Energy Storage Mater. 31, 434 (2020).
42. Liu, Y., Zhao, T., Ju, W. & Shi, S. Materials discovery and design using machine learning. J. Materiomics 3, 159 (2017).
43. Butler, K. T., Davies, D. W., Cartwright, H., Isayev, O. & Walsh, A. Machine learning for molecular and materials science. Nature 559, 547 (2018).
44. Landrum, G. RDKit: A software suite for cheminformatics, computational chemistry, and predictive modeling. (2013). https://www.rdkit.org
45. Damewood, J., Karaguesian, J., Lunger, J. R., Tan, A. R., Xie, M., Peng & Gómez-Bombarelli R. Representations of materials for machine learning. Annu. Rev. Mater. Res. 53, 399 (2023)
46. Atz, K., Grisoni, F. & Schneider, G. Geometric deep learning on molecular representations. Nat. Mach. Intell. 3, 1023 (2021).
47. Tao, L., Chen, G. & Li, Y. Machine learning discovery of high-temperature polymers. Patterns 2, 100335 (2021).
48. Kim, C., Chandrasekaran, A., Huan, T. D., Das, D. & Ramprasad, R. Polymer genome: A data-powered polymer informatics platform for property predictions. J. Phys. Chem. C 122, 17575 (2018).
49. Zhu, W. Li, F., Liu, J., Ma, X. & Jiang, X. Nucleophilic construction of sulfate bond: A simplified access to polysulfates and polysulfonates. React. Chem. Eng. 4, 2074 (2019).
50. Ertl, P., & Ansgar S. Estimation of synthetic accessibility score of drug-like molecules based on molecular complexity and fragment contributions. J. Cheminformatics 1, 8 (2009).
51. Wu, S., Kondo, Y., Kakimoto, M.-A., Yang, B., Yamada, H., Kuwajima, I., Lambard, G., Hongo, K., Xu, Y., Shiomi, J., Schick, C., Morikawa, J. & Yoshida, R. Machine-learning-assisted discovery of polymers with high thermal conductivity using a molecular design algorithm. npj Comput. Mater. 5, 66 (2019).
52. Deshmukh, A. A., Wu, C., Yassin, O., Mishra, A., Chen, L., Alamri, A., Li, Z., Zhou, J., Mutlu, Z., Sotzing, M., Rajak, P., Shukla, S., Vellek, J., Baferani, M. A., Cakmak, M., Vashishta, P., Ramprasad, R., Cao, Y. & Sotzing, G. Flexible polyolefin dielectric by strategic design of organic modules for harsh condition electrification. Energy Environ. Sci. 15, 1307 (2022).
53. Chen, J., Zhou, Y., Huang, X., Yu, C., Han, D., Wang, A., Zhu, Y., Shi, K., Kang, Q., Li, P., Jiang, P., Qian, X., Bao, H., Li, S., Wu, G., Zhu, X. & Wang, Q. Ladderphane copolymers for high-temperature capacitive energy storage. Nature 615, 62 (2023).
54. Qin, H., Song, J., Liu, M., Zhang, Y., Qin, S., Chen, H., Shen, K., Wang, S., Li, Q., Yang, Q. & Xiong, C. High-temperature polymer dielectrics with superior capacitive energy storage performance. Chem. Eng. J. 461, 142068 (2023).
55. Chen, J., Pei, Z., Liu, Y., Shi, K., Zhu, Y., Zhang, Z., Jiang, P. & Huang, X. Aromatic-free polymers based all-organic dielectrics with breakdown self-healing for high-temperature capacitive energy storage. Adv. Mater. 35, 2306562 (2023).
56. Zhang, G., Li, Q., Allahyarov, E., Li, Y. & Zhu L. Challenges and opportunities of polymer nanodielectrics for capacitive energy storage. ACS Appl. Mater. Interfaces 13, 37939 (2021).
57. Li, Q., Yao, F.-Z., Liu, Y., Zhang, G., Wang, H. & Wang, Q. High-temperature dielectric materials for electrical energy storage. Annu. Rev. Mater. Res. 48, 219 (2018).
58. Zhang, T., Sun, H., Yin, C., Jung, Y. H., Min, S., Zhang, Y., Zhang, C., Chen, Q., Lee, K. J. & Chi, Q. Recent progress in polymer dielectric energy storage: From film fabrication and modification to capacitor performance and application. Prog. Mater. Sci. 140, 101207 (2023).
59. Li, Q. Chen, L., Gadinski, M. R., Zhang, S., Zhang, G., Li, H. U., Iagodkine, E., Haque, A., Chen, L.-Q., Jackson, T. N. & Wang, Q. Flexible high-temperature dielectric materials from polymer nanocomposites. Nature 523, 576 (2015).
60. Wei, J. & Zhu, L. Intrinsic polymer dielectrics for high energy density and low loss electric energy storage. Prog. Polym. Sci. 106, 101254 (2020).
61. Zha, J.-W., Zheng, M.-S., Fan, B.-H. & Dang, Z.-M. Polymer-based dielectrics with high permittivity for electric energy storage: A review. Nano Energy 89, 106438 (2021).
62. Li, H., Zhou, Y., Liu, Y., Li, L., Liu, Y. & Wang, Q. Dielectric polymers for high-temperature capacitive energy storage. Chem. Soc. Rev. 50, 6369 (2021).
63. Zhang, Z., Wang, H., Litt, M. H., Tan, L.-S. & Zhu, L. High-temperature and high-energy-density dipolar glass polymers based on sulfonylated poly(2,6-dimethyl-1,4-phenylene oxide). Angew. Chem. Int. Ed. 57, 1528 (2018).
64. Li, Z., Wu, C., Chen, L., Wang, Y., Mutulu, Z., Uehara, H., Zhou, J., Cakmak, M., Ramprasad, R. & Cao, Y. Probing electronic band structures of dielectric polymers via pre-breakdown conduction. Adv. Mater. 2310497, (2024). https://doi.org/10.1002/adma.202310497
65. Ju, T., Treufeld, I., Wolak, M., Ponting, M., Baer, E. & Zhu, L. Effect of glass transition temperature on enhanced dielectric breakdown strength and lifetime of multilayer polymer films. ACS Appl. Mater. Interfaces 16, 795 (2024).
66. Yang, M., Li, H., Wang, J., Shi, W., Zhang, Q., Xing, H., Ren, W., Sun, B., Guo, M., Xu, E., Sun, N., Zhou, L., Xiao, Y., Zhang, M., Li, Z., Pan, J., Jiang, J., Shen, Z., Li, X., Gu, L., Nan, C.-W., Wang, X. & Shen, Y. Roll-to-roll fabricated polymer composites filled with subnanosheets exhibiting high energy density and cyclic stability at 200° C. Nat. Energy 9, 143 (2024).
67. Liu, Y., Yang, Z., Zou, X., Ma, S., Liu, D., Avdeev, M. Shi, S. Data quantity governance for machine learning in materials science. Natl. Sci. Rev. 10, nwad125 (2023)
68. Chen, H., Chen, J. Ding, J. Data evaluation and enhancement for quality improvement of machine learning. IEEE Trans. Reliab. 70, 831 (2021).

All publications (e.g., patents and patent applications) cited herein are incorporated herein by reference in their entireties.

1. A dielectric polymer comprising repeating units of formula I: 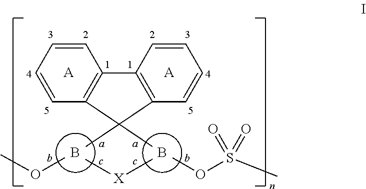
wherein:
each ring A is optionally substituted at one or more of positions 2-5 with R¹ such that the substitution at each of positions 2-5 is the same in each ring A;
each ring B is indenyl, naphthyl, tetrahydronaphthyl, anthryl, or optionally substituted phenyl, which optional substitution is at one or more positions with R² such that the substitution at each of the positions is the same in each ring B;
when B is optionally substituted phenyl, bonds a and b are para and bonds a and c are ortho; when B is indenyl, bonds a and b are 4 carbons apart; when B is naphthyl or tetrahydronaphthyl, bonds a and b are 5 carbons apart; and when B is anthryl, bonds a and b are 7 carbons apart;
each R¹ is independently halo, methyl, CF₃, cyano, phenyl, or SO₂CH₃;
each R² is independently halo, methyl, CF₃, cyano, phenyl, or SO₂CH₃;
X is absent when A is not optionally substituted phenyl; when A is optionally substituted phenyl, X is absent or is a bond, O, S, S(O), CH₂, or C(CH₃)₂; and
n is the average number of repeating units in the polymer and is greater than 100; provided that:
when each ring A is unsubstituted phenyl and X is absent or O, B is not unsubstituted phenyl;
when each ring A is monosubstituted with R¹ at position 4, R¹ is Br, and X is absent, B is not unsubstituted phenyl; and
when each ring A is unsubstituted phenyl, B is not naphthyl.

2. The dielectric polymer of claim 1, wherein the repeating units are of formula II: 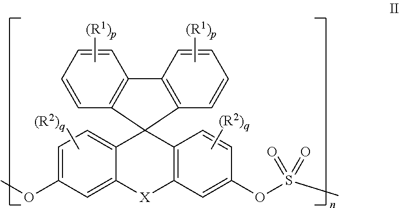
wherein p is 0-3 and q is 0-3.

3. The dielectric polymer of claim 2, wherein p is 0 or 1.

4-6. (canceled)

7. The dielectric polymer of claim 2, wherein the repeating units are of formula II(a):

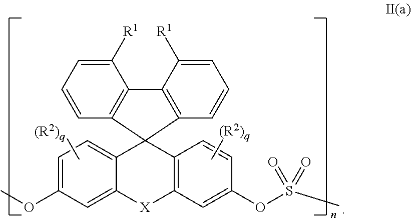

8. The dielectric polymer of claim 2, wherein the repeating units are of formula II(b):

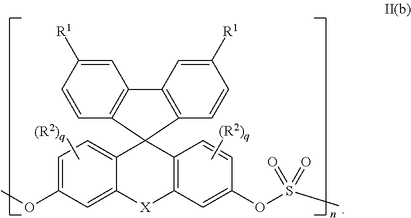

9. The dielectric polymer of claim 2, wherein the repeating units are of formula II(c):

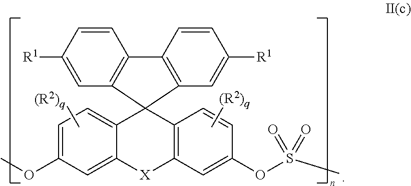

10. The dielectric polymer of claim 2, wherein X is absent.

11. The dielectric polymer of claim 2, wherein X is O.

12-13. (canceled)

14. The dielectric polymer of claim 2, wherein at least one R¹ is halo.

15. The dielectric polymer of claim 2, wherein at least one R¹ is methyl or CF₃.

16. The dielectric polymer of claim 2, wherein at least one R¹ is cyano.

17. (canceled)

18. The dielectric polymer of claim 2, wherein at least one R¹ is SO₂CH₂.

19. The dielectric polymer of claim 2, wherein q is 0 or 1.

20-22. (canceled)

23. The dielectric polymer of claim 2, wherein at least one R² is halo.

24-28. (canceled)

29. The dielectric polymer of claim 1, wherein the repeating units are of formula IV: 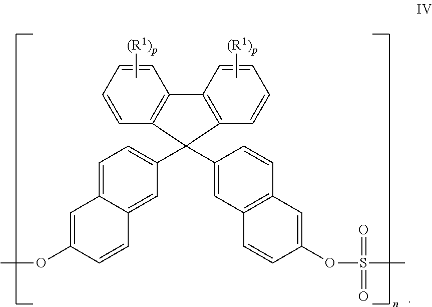
wherein p is 1-3.

30-40. (canceled)

41. A dielectric film comprising a first layer and a second layer, wherein the first layer comprises a dielectric polymer of claim 1 and the second layer comprises an inorganic dielectric material.

42-45. (canceled)

46. A material useful for storing electrostatic energy, which material comprises a first conductive layer, a second conductive layer, and a dielectric polymer disposed between the first and second conductive layers, wherein the dielectric polymer is of claim 1.

47. (canceled)

48. A compound of formula A: 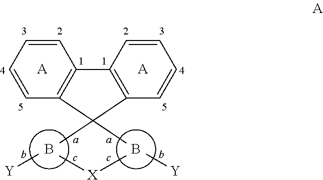
wherein:
each ring A is optionally substituted at one or more of positions 2-5 with R¹ such that the substitution at each of positions 2-5 is the same in each ring A;
each ring B is indenyl, naphthyl, tetrahydronaphthyl, anthryl, or optionally substituted phenyl, which optional substitution is at one or more positions with R² such that the substitution at each of the positions is the same in each ring B;
when B is optionally substituted phenyl, bonds a and b are para and bonds a and c are ortho; when B is indenyl, bonds a and b are 4 carbons apart; when B is naphthyl or tetrahydronaphthyl, bonds a and b are 5 carbons apart; and when B is anthryl, bonds a and b are 7 carbons apart;
each R¹ is independently halo, methyl, CF₃, cyano, phenyl, or SO₂CH₃;
each R² is independently halo, methyl, CF₃, cyano, phenyl, or SO₂CH₃;
X is absent when A is not optionally substituted phenyl; when A is optionally substituted phenyl, X is absent or is a bond, O, S, S(O), CH₂, or C(CH₃)₂;
n is the average number of repeating units in the polymer and is greater than 100; and
and Y is OH, OTBS, or OSO₂F;
provided that:
when each ring A is unsubstituted phenyl and X is absent or O, B is not unsubstituted phenyl;
when each ring A is monosubstituted with R¹ at position 4, R¹ is Br, and X is absent, B is not unsubstituted phenyl; and when each ring A is unsubstituted phenyl, B is not naphthyl.

49-53. (canceled)

54. A method of preparing a dielectric polymer, which comprises:
contacting a compound formula A(1): 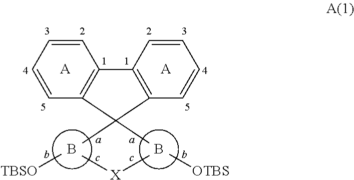
with a compound of formula A(2): 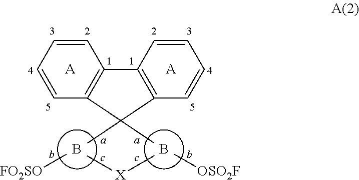
in the presence of a catalyst under conditions sufficient to provide a dielectric polymer of formula I: 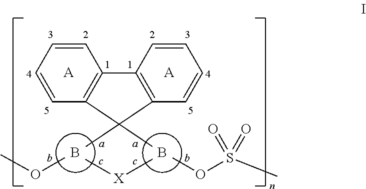
wherein:
each ring A is optionally substituted at one or more of positions 2-5 with R¹ such that the substitution at each of positions 2-5 is the same in each ring A;
each ring B is indenyl, naphthyl, tetrahydronaphthyl, anthryl, or optionally substituted phenyl, which optional substitution is at one or more positions with R² such that the substitution at each of the positions is the same in each ring B;
when B is optionally substituted phenyl, bonds a and b are para and bonds a and c are ortho; when B is indenyl, bonds a and b are 4 carbons apart; when B is naphthyl or tetrahydronaphthyl, bonds a and b are 5 carbons apart; and when B is anthryl, bonds a and b are 7 carbons apart;
each R¹ is independently halo, methyl, CF₃, cyano, phenyl, or SO₂CH₃;
each R² is independently halo, methyl, CF₃, cyano, phenyl, or SO₂CH₃;
X is absent when A is not optionally substituted phenyl; when A is optionally substituted phenyl, X is absent or is a bond, O, S, S(O), CH₂, or C(CH₃)₂; and
n is the average number of repeating units in the polymer and is greater than 100;
provided that:
when each ring A is unsubstituted phenyl and X is absent or O, B is not unsubstituted phenyl;
when each ring A is monosubstituted with R¹ at position 4, R¹ is Br, and X is absent, B is not unsubstituted phenyl; and
when each ring A is unsubstituted phenyl, B is not naphthyl.

55-82. (canceled)

83. A dielectric polymer preparable or prepared by the method of claim 54.

84-86. (canceled)

87. A dielectric film comprising a first layer and a second layer, wherein the first layer comprises a dielectric polymer of claim 83 and the second layer comprises an inorganic dielectric material.

88-91. (canceled)

92. A material useful for storing electrostatic energy, which material comprises a first conductive layer, a second conductive layer, and a dielectric polymer disposed between the first and second conductive layers, wherein the dielectric polymer is of claim 83.

93. (canceled)
